(19) United States
(12) Patent Application Publication
(10) Pub. No.: US 2007/0185696 A1
(43) Pub. Date: Aug. 9, 2007

(54) METHOD OF REAL-TIME DRILLING SIMULATION

(75) Inventors: David P. Moran, Woodlands, TX (US); Stuart R. Oliver, Magnolia, TX (US); Sujian J. Huang, Beijing (CN); Luis C. Paez, The Woodlands, TX (US); Lei Yan, Houston, TX (US)

Correspondence Address: OSHA, LIANG LLP / SMITH, 1221 MCKINNEY STREET, SUITE 2800, HOUSTON, TX, 77010, US

(73) Assignee: SMITH INTERNATIONAL, INC., Houston, TX (US)

(21) Appl. No.: 11/670,696

(22) Filed: Feb. 2, 2007

Related U.S. Application Data
(60) Provisional application No. 60/765,557, filed on Feb. 6, 2006.
(60) Provisional application No. 60/865,732, filed on Nov. 14, 2006.

(51) Int. Cl. G06G 7/48

(52) U.S. Cl. 703/10

(57) ABSTRACT

A method of optimizing drilling including identifying design parameters for a drilling tool assembly, preserving the design parameters as experience data, and training at least one artificial neural network using the experience data. The method also includes collecting real-time data from the drilling operation, analyzing the real-time data with a real-time drilling optimization system, and determining optimal drilling parameters based on the analyzing the real-time date with the real-time drilling optimization system. Also, a method for optimizing drilling in real-time including collecting real-time data from a drilling operation and comparing the real-time data against predicted data in a real-time optimization system, wherein the real-time optimization includes at least one artificial neural network. The method further includes determining optimal drilling parameters based on the comparing the real-time data with the predicted data in the real-time drilling optimization system.

### CROSS-REFERENCE TO RELATED APPLICATIONS

This application claims priority, pursuant to 35 U.S.C. §119, U.S. Provisional Application No. 60/765,557, filed Feb. 6, 2006. This application also claims priority, pursuant to 35 U.S.C. §119, U.S. Provisional Application 60/865,732, filed Nov. 14, 2006. Both patents, along with U.S. Provisional Patent Application No. 60/765,694, are hereby incorporated by reference in their entirety.

### BACKGROUND

1. Field of the Disclosure

Embodiments disclosed herein are related generally to the field of well drilling. More specifically, embodiments disclosed herein relate to methods for optimizing drilling. More specifically still, embodiments disclosed herein relate to real-time methods for determining optimized drilling parameters while drilling a wellbore.

2. Background Art

FIG. 1 shows one example of a conventional drilling system for drilling an earth formation. The drilling system includes a drilling rig 10 used to turn a drilling tool assembly 12 which extends downward into a wellbore 14. Drilling tool assembly 12 includes a drilling string 16, a bottom hole assembly (“BHA”) 18, and a drill bit 20, attached to the distal end of drill string 16.

Drill string 16 comprises several joints of drill pipe 16a connected end to end through tool joints 16b. Drill string 16 transmits drilling fluid (through its central bore) and transmits rotational power from drill rig 10 to BHA 18. In some cases drill string 16 further includes additional components such as subs, pup joints, etc. Drill pipe 16a provides a hydraulic passage through which drilling fluid is pumped. The drilling fluid discharges through selected-size orifices in the bit (“jets”) for the purposes of cooling the drill bit and lifting rock cuttings out of the wellbore as it is being drilled.

Bottom hole assembly 18 includes a drill bit 20. Typical BHAs may also include additional components attached between drill string 16 and drill bit 20. Examples of additional BHA components include drill collars, stabilizers, measurement-while-drilling (“MWD”) tools, logging-while-drilling (“LWD”) tools, and downhole motors.

In general, drilling tool assemblies 12 may include other drilling components and accessories, such as special valves, kelly cocks, blowout preventers, and safety valves. Additional components included in drilling tool assemblies 12 may be considered a part of drill string 16 or a part of BHA 18 depending on their locations in drilling tool assembly 12.

Drill bit 20 in BHA 18 may be any type of drill bit suitable for drilling earth formation. The most common types of earth boring bits used for drilling earth formations are fixed-cutter (or fixed-head) bits, roller cone bits, and percussion bits. FIG. 2 shows one example of a fixed-cutter bit. FIG. 3 shows one example of a roller cone bit.

Referring now to FIG. 2, fixed-cutter bits (also called drag bits) 21 typically comprise a bit body 22 having a threaded connection at one end 24 and a cutting head 26 formed at the other end. Cutting head 26 of fixed-cutter bit 21 typically comprises a plurality of ribs or blades 28 arranged about a rotational axis of the bit and extending radially outward from bit body 22. Cutting elements 29 are preferably embedded in the blades 28 to engage formation as bit 21 is rotated on a bottom surface of a wellbore. Cutting elements 29 of fixed-cutter bits may comprise polycrystalline diamond compacts (“PDC”), specially manufactured diamond cutters, or any other cutter elements known to those of ordinary skill in the art. These bits 21 are generally referred to as PDC bits.

Referring now to FIG. 3, a roller cone bit 30 typically comprises a bit body 32 having a threaded connection at one end 34 and one or more legs 31 extending from the other end. A roller cone 36 is mounted on a journal (not shown) on each leg 31 and is able to rotate with respect to bit body 32. On each cone 36, a plurality of cutting elements 38 are shown arranged in rows upon the surface of cone 36 to contact and cut a formation encountered by bit 30. Roller cone bit 30 is designed such that as it rotates, cones 36 of bit 30 roll on the bottom surface of the wellbore and cutting elements 38 engage the formation therebelow. In some cases, cutting elements 38 comprise milled steel teeth and in other cases, cutting elements 38 comprise hard metal inserts embedded in the cones. Typically, these inserts are tungsten carbide inserts or polycrystalline diamond compacts, but in some cases, hardfacing is applied to the surface of the cutting elements to improve wear resistance of the cutting structure.

Referring again to FIG. 1, for drill bit 20 to drill through formation, sufficient rotational moment and axial force must be applied to bit 20 to cause the cutting elements to cut into and/or crush formation as bit 20 is rotated. Axial force applied to bit 20 is typically referred to as the weight on bit (“WOB”). Rotational moment applied to drilling tool assembly 12 by drill rig 10 (usually by a rotary table or a top drive) to turn drilling tool assembly 12 is referred to as the rotary torque. The speed at which drilling rig 10 rotates drilling tool assembly 12, typically measured in revolutions per minute (“RPM”), is referred to as the rotary speed. Additionally, the portion of the weight of drilling tool assembly 12 supported by a suspending mechanism of rig 10 is typically referred to as the hook load.

The speed and economy with which a wellbore is drilled, as well as the quality of the hole drilled, depend on a number of factors. These factors include, among others, the mechanical properties of the rocks which are drilled, the diameter and type of the drill bit used, the flow rate of the drilling fluid, and the rotary speed and axial force applied to the drill bit, It is generally the case that for any particular mechanical property of a formation, a drill bit's rate of penetration (“ROP”) corresponds to the amount of axial force on and the rotary speed of the drill bit. The rate at which the drill bit wears out is generally related to the ROP. Various methods have been developed to optimize various drilling parameters to achieve various desirable results.

Prior art methods for optimizing values for drilling parameters that primarily involve looking at the formation have focused on the compressive strength of the rock being drilled. For example, U.S. Pat. No. 6,346,595, issued to Civolani, el al. (“the '595 patent”), and assigned to the assignee of the present invention, discloses a method of selecting a drill bit design parameter based on the compressive strength of the formation. The compressive strength of the formation may be directly measured by an indentation test performed on drill cuttings in the drilling fluid returns. The method may also be applied to determine the likely optimum drilling parameters such as hydraulic requirements, gauge protection, WOB, and the bit rotation rate. The '595 patent is hereby incorporated by reference in its entirety.

U.S. Pat. No. 6,424,919, issued to Moran, et a. (“the '919 patent”), and assigned to the assignee of the present invention, discloses a method of selecting a drill bit design parameter by inputting at least one property of a formation to be drilled into a trained Artificial Neural Network (“ANN”). The '919 patent also discloses that a trained ANN may be used to determine optimum drilling operating parameters for a selected drill bit design in a formation having particular properties. The ANN may be trained using data obtained from laboratory experimentation or from existing wells that have been drilled near the present well, such as an offset well. The '919 patent is hereby incorporated by reference in its entirety.

ANNs are a relatively new data processing mechanism. ANNs emulate the neuron interconnection architecture of the human brain to mimic the process of human thought. By using empirical pattern recognition, ANNs have been applied in many areas to provide sophisticated data processing solutions to complex and dynamic problems (e.g., classification, diagnosis, decision making, prediction, voice recognition, military target identification).

Similar to the human brain's problem solving process, ANNs use information gained from previous experience and apply that information to new problems and/or situations. The ANN uses a “training experience” (i.e., the data set) to build a system of neural interconnects and weighted links between an input layer (i.e., independent variable), a hidden layer of neural interconnects, and an output layer (i.e., the dependant variables or the results). No existing model or known algorithmic relationship between these variables is required, but such relationships may be used to train the ANN. An initial determination for the output variables in the training exercise is compared with the actual values in a training data set. Differences are back-propagated through the ANN to adjust the weighting of the various neural interconnects, until the differences are reduced to the user's error specification. Due largely to the flexibility of the learning algorithm, non-linear dependencies between the input and output layers, can be “learned” from experience.

Several references disclose various methods for using ANNs to solve various drilling, production, and formation evaluation problems. These references include U.S. Pat. No. 6,044,325 issued to Chakravarthy, et al., U.S. Pat. No. 6,002,985 issued to Stephenson, et al., U.S. Pat. No. 6,021,377 issued to Dubinsky, et al., U.S. Pat. No. 5,730,234 issued to Putot, U.S. Pat. No. 6,012,015 issued to Tubel, and U.S. Pat. No. 5,812,068 issued to Wisler, et al.

However, one skilled in the art will recognize that optimization predictions from these methods may not be as accurate as simulations of drilling, which may be better equipped to make predictions for each unique situation.

Simulation methods have been previously introduced which characterize either the interaction of a bit with the bottom hole surface of a wellbore or the dynamics of BHA.

One simulation method for characterizing interaction between a roller cone bit and an earth formation is described in U.S. Pat. No. 6,516,293 (“the '293 patent”), entitled “Method for Simulating Drilling of Roller Cone Bits and its Application to Roller Cone Bit Design and Performance,” and assigned to the assignee of the present invention. The '293 patent discloses methods for predicting cutting element interaction with earth formations. Furthermore, the '293 patent discloses types of experimental tests that can be performed to obtain cutting element/formation interaction data. The '293 patent is hereby incorporated by reference in its entirety. Another simulation method for characterizing cutting element/formation interaction for a roller cone bit is described in Society of Petroleum Engineers (SPE) Paper No. 29922 by D. Ma et al., entitled, “The Computer Simulation of the Interaction Between Roller Bit and Rock”.

Methods for optimizing tooth orientation on roller cone bits are disclosed in PCT International Publication No. WO00/12859 entitled, “Force-Balanced Roller-Cone Bits, Systems, Drilling Methods, and Design Methods” and PCT International Publication No. WO00/12860 entitled, “Roller-Cone Bits, Systems, Drilling Methods, and Design Methods with Optimization of Tooth Orientation.

Similarly, SPE Paper No. 15618 by T. M. Warren et al., entitled “Drag Bit Performance Modeling” discloses a method for simulating the performance of PDC bits. Also disclosed are methods for defining the bit geometry and methods for modeling forces on cutting elements and cutting element wear during drilling based on experimental test data. Examples of experimental tests that can be performed to obtain cutting element/earth formation interaction data are also disclosed. Experimental methods that can be performed on bits in earth formations to characterize bit/earth formation interaction are discussed in SPE Paper No. 15617 by T. M. Warren et al., entitled “Laboratory Drilling Performance of PDC Bits”.

Present systems for optimizing drilling parameters, as described above, focus on either optimizing drilling components or optimizing drilling conditions. Drilling components may be optimized by tailoring such components for specific well conditions. During such design processes, drill bits, BHAs, drillstrings, and/or drilling tool assemblies may be simulated and adjusted according to the anticipated formation the drilling tool will be drilling. These design processes may involve complex simulations including three dimensional modeling, finite element analysis, and/or graphical representations. Such design processes may require vast amounts of time that, while still in the design and manufacturing stage may be readily available. However, while drilling a wellbore, when downhole conditions change, or when the formation deviates from the anticipated structure, even optimized components may fail or be less efficient than predicted.

During drilling operations, drilling operators may rely on historical data sets, offset well formation data, monitored downhole drilling conditions, and personal experience to anticipate and/or determine when a wellbore condition has changed. A drilling operator may decide to change drilling parameters (e.g., axial load, rotational speed, drilling fluid flow rate, etc.) in response to changing downhole conditions. However, the drilling operator's response may be based on a limited number of options and/or experiences. Alternatively, the drilling operator may research the given conditions, and base a drilling parameter adjustment on such research. However, during drilling, running programs that calculate optimized drilling parameter adjustment are time intensive and may result in substantial rig downtime.

Thus, there exists a need for a real-time drilling optimization environment to determine drilling parameter adjustments in a timely manner while drilling in a dynamic environment.

### SUMMARY OF THE DISCLOSURE

In one aspect, embodiments disclosed herein relate to a method of optimizing drilling including identifying design parameters for a drilling tool assembly, preserving the design parameters as experience data, and training at least one artificial neural network using the experience data. The method also relates to collecting real-time data from the drilling operation, analyzing the real-time data with a real-time drilling optimization system, and determining optimal drilling parameters based on the analyzing the real-time date with the real-time drilling optimization system.

In another aspect, embodiments disclosed herein relate to a method for optimizing drilling in real-time including collecting real-time data from a drilling operation and comparing the real-time data against predicted data in a real-time optimization system, wherein the real-time optimization includes at least one artificial neural network. The method further includes determining optimal drilling parameters based on the comparing the real-time data with the predicted data in the real-time drilling optimization system.

In another aspect, embodiments disclosed herein relate to a method for optimizing drilling in real-time including collecting real-time data from a first segment of a bit run and inputting the real-time data into a real-time optimization system, wherein the real-time optimization system includes at least one artificial neural network. The method further includes analyzing the real-time data from the first segment with the real-time drilling optimization system, and determining optimal drilling parameters fro a second segment of the bit run with the real-time drilling optimization system based on the analyzing the real-time data from the first segment.

Other aspects and advantages of the present disclosure will be apparent from the following description and the appended claims.

### BRIEF DESCRIPTION OF DRAWINGS

FIG. 1 is an illustration of a typical drilling system.

FIG. 2 is a perspective-view drawing of a fixed-cutter bit.

FIG. 3 is a perspective-view drawing of a roller cone bit.

FIG. 4 is a flowchart diagram of a method for optimizing drilling in accordance with an embodiment of the present disclosure.

FIG. 5 is a flowchart diagram of a method to identify design parameters for a drilling tool assembly in accordance with embodiments of the present disclosure.

FIG. 6 is a flowchart diagram of a method to identify design parameters for a drilling tool assembly in accordance with embodiments of the present disclosure.

FIGS. 7A-D are flowchart diagrams of methods to identify design parameters for a drilling tool assembly in accordance with embodiments of the present disclosure.

FIG. 7E is a visual representation in accordance with an embodiment of the present disclosure.

FIG. 8 is a schematic representation of communication connections relating to a drilling process in accordance with an embodiment of the present disclosure.

FIG. 9 is a schematic representation of a rig network in accordance with an embodiment of the present disclosure.

FIG. 10A-B is a flowchart diagram of a method of real-time drilling simulation in accordance with an embodiment of the present disclosure.

FIG. 11 is a flowchart diagram of a method of training an artificial neural network in accordance with an embodiment of the present disclosure.

FIG. 12 is a flow diagram of a method to simulate drilling in real-time in accordance with embodiments of the present disclosure.

FIG. 13 is a flow diagram of a method for simulating drilling in real-time in accordance with embodiments of the present disclosure.

### DETAILED DESCRIPTION

In one or more embodiments, the present disclosure relates to methods for drilling optimization. More specifically, embodiments of the present disclosure relate to a method for the real-time optimization of drilling parameters based on experience data analyzed by an artificial neural network.

The following discussion contains definitions of several specific terms used in this disclosure. These definitions are intended to clarify the meanings of the terms used herein. It is believed that the terms are used in a manner consistent with their ordinary meaning, but the definitions are nonetheless specified here for clarity.

The term “real-time”, as defined in the McGraw-Hill Dictionary Scientific and Technical Terms (6th ed., 2003), pertains to a data-processing system that controls an ongoing process and delivers its outputs (or controls its inputs) not later than the time when these are needed for effective control. In this disclosure, simulating “in real-time” means that simulations are performed with current drilling parameters on a predicted upcoming formation segment and the results are obtained before the predicted upcoming formation segment is drilled. Thus, “real-time” is not intended to require that the process is “instantaneous.”

The term “current formation information” refers to information that is obtained from analyzing material samples in the formation that is being drilled. As mentioned before, the term is not limited to information from the instant formation segment being drilled, but also includes the formation segments that have already been drilled, as long as it is part of the formation that is being drilled.

The term “offset well formation information” refers to formation information that is obtained from drilling an offset well in the vicinity of the formation that is being drilled.

The term “historical formation information” refers to formation information that has been obtained prior to the start of drilling for the formation that is being drilled. It could include, for example, information related to a well drilled in the same general area as the current well, information related to a well drilled in a geologically similar area, or seismic or other survey data.

The “offset well formation information” could qualify as “historical formation information” under the given definitions if the offset well was drilled prior to the start of drilling for the formation that is being drilled. However, for clarity, the two terms are separated. In other words, “historical formation information” as used in this disclosure does not include the “offset well formation information,” although it could conceivably include formation information from offset wells not in the vicinity of the current well.

The term “current well” is the well which is being drilled, and on which the simulation in real-time is being performed.

The term “drilling parameter” is any parameter that affects the way in which the well is being drilled. For example, the WOB is an important parameter affecting the drilling well. Other drilling parameters include the torque-on-bit (“TOB”), the rotary speed of the drill bit (“RPM”), and the mud flow rate. There are numerous other drilling parameters, as is known in the art, and the term is meant to include any such parameter.

The term “current drilling parameter” refers to a value of a drilling parameter that is being used at the moment the simulation is initiated. Of course, no information transfer is truly instantaneous, so it could also refer to a value of a drilling parameter that was used a short time before the simulation is initiated.

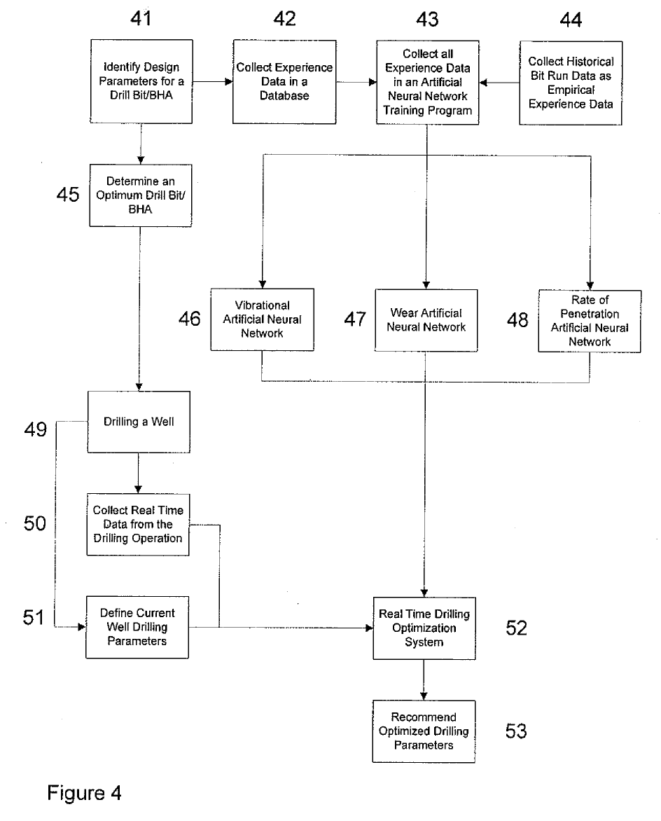

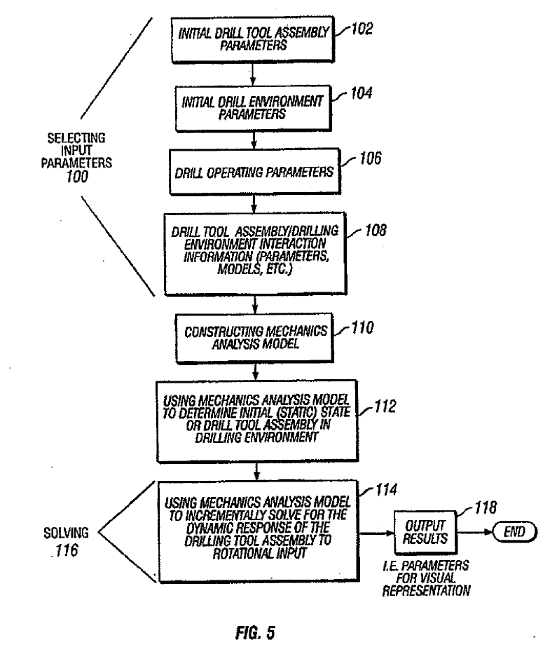

Referring initially to FIG. 4, a flowchart diagram of a method for optimizing drilling in accordance with an embodiment of the present disclosure is shown. Prior to drilling a well, a number of design criteria are determined and collected in multiple studies. Such studies may be performed to predict, for example, optimized bit/BHA design, drilling tool assembly design, and well plans. These studies will be described in detail below; however, generally, a first study may include the identification of design parameters for a drill bit/BHA 41. This study may identify a preferred BHA and drill bit selection for a given well path, wellbore geometry, drilling conditions, etc. An example of a first study is described in U.S. Pat. No. 6,785,641, assigned to the assignee of the present application, and hereby incorporated in its entirety.

In the first study, while determining an optimum drill bit/BHA 45, the system may provide a number of simulations for a given bit/BHA, thereby developing a matrix of drilling parameter combinations and optimal operational ranges. In certain embodiments the number of simulations may be limited to, for example, less than 10 simulations. However, in alternate embodiments, several hundred, or potentially several thousand simulations may occur. These simulations and/or matrices are preserved in a database, and collected as experience data 42. Such experience data may later be used in an ANN training program, for training specific functioning ANNs 43, as will be described in greater detail below.

A second study may include a collection of historical bit run data and other empirical data that may be used as additional experience data 44. An example of a second study is described in U.S. Pat. No. 7,142,986, assigned to the assignee of the present application and hereby incorporated in its entirety. Data from both simulated and prior bit runs may be incorporated as experience data that may later be used in an ANN training program for training specific functioning ANNs 43. Additionally, in some embodiments, the data from second study 44 may also be used in determining optimum drill bit/BHA design 45, as described above.

Experience data (e.g., the simulation inputs and results) from both first study 41, and second study 44 is collected in a data base that is accessible to the ANN training program 43. ANN training program 43 analyzes the collection of experience data, therein training a number of ANNs 46, 47, 48 that are capable of determining a resultant condition for a bit/EHA across a range of drilling conditions (e.g., formation types and rock strengths) according to specified drilling parameter combinations. Examples of such trained ANNs include vibrational ANN 46, bit wear ANN 47, and ROP ANN 48. One of ordinary skill in the art will appreciate that additional ANNs may be trained that allow the prediction and analysis of other drilling conditions. The limited number of ANNs discussed below are illustrative only, and are not meant as a limitation on the scope of the present disclosure.

When a well is drilled 49, a number of drilling parameters are incorporated into the drilling operation. Drilling parameters may include, for example, RPMs and WOB. In one embodiment, current drilling conditions are collected in real-time 50, current well drilling parameters are defined 51, and the data (50 and 51 collectively) is input into a real-time drilling optimization system 52. Real-time drilling optimization system 52 accesses, or includes, trained ANNs 46, 47, 48, and analyzes data 50, 51. Because ANNs 46, 47, and 48 have already been trained to include matrices of data for a bit/BHA in different formations and drilling conditions, as described above, real-time drilling optimization system 52 may recommend optimized drilling parameters 53 in real-time or near real-time. Thus, recommended optimized drilling parameters 53 ranges, such as, for example, ROP and WOB ranges, may be suggested to a drilling operator.

In one embodiment, real-time drilling optimization system 52 receives real-time data collected from the drilling operation 50. The data 50 may be combined with additional data, including offset well formation data and current well plan data, and analyzed by vibration ANN 46. Real-time drilling optimization system 52 feeds in lithologic data, compression data, and abrasion descriptive data for the fill expected drilling segment of the planned bit run, on a step-by-step basis. Such lithologic, compression, and abrasion descriptive data may be available from any number of methods known to those of ordinary skill in the art, including from offset well data, by monitoring downhole conditions, or by analyzing historical well data. By reviewing real-time data on a step-by-step basis, the real-time drilling optimization system 52 breaks up a planned bit run into smaller segments, and each segment is tested by vibrational ANN 46 at a range of proposed parameters. The analyzed parameters may include the effects of changing, for example, a TOB, a WOB, or a drilling fluid parameter, and determining the result effects on the vibrational conditions to the drillstring and/or drillbit. Vibrational ANN 46 then defines a sub-set of working range parameters that would not cause destructive system vibrations to the drilling system. Optimal drilling parameter ranges for a minimally destructive vibration signature may then be defined for each segment of the planned bit run by the real-time drilling optimization system 52.

Real-time drilling optimization system 52 may then continue to optimize drilling parameter combinations at each segment to manage bit wear. The optimal ranges of vibrational signature determined by vibrational ANN 46 may then be input into bit wear ANN 47. Bit wear ANN 47 may then analyze the data and determine optimum drilling parameters so that a desired dull bit condition at the end of each drilling segment is determined. The desired dull bit condition may be determined by bit wear ANN 47 by comparing real-time data, historical data, prior determined vibrational data (i.e., data determined by vibrational ANN 46), or by analyzing any other data as may be known to one of ordinary skill in the art. Bit wear ANN 47 may then compare the real-time conditions against the matrices generated while training the ANN to produce a range of drilling parameters that may produce a desired effect (e.g., an end run dull wear condition).

With such dull bit condition and vibrational signal determined, real-time drilling optimization system 52 may predict the resulting ROP, and recommend adjusted drilling parameters to further optimize the ROP, through data generated during the training of ROP ANN 48. Furthermore, by taking into account the data ranges generated by vibrational ANN 46 and bit wear ANN 47, the expected ROP at each segment of the planned drill segment may be determined. However, one of ordinary skill in the art will appreciate that in certain embodiments, it may be preferable to include additional bit run data, lithologic data, compression data, and abrasion descriptive data to be compared against the ROP matrices when generating predicted and optimized ROP determinations.

Because real-time drilling optimization system 52 has access to vibrational ANN 46, bit wear ANN 47, and ROP ANN 48, the optimization range at each drill segment may be limited to the range limits defined by, for example, the vibration constraint determined by vibrational ANN 46. Thus, a final recommended optimized drilling parameter 53, at each depth step, may include drilling vibration management, bit life management, predicted ROP, or other economic performance factors resulting from recommended drilling parameters 53.

While the above described embodiment has been described wherein real-time optimization system 52 includes generated data preserved from trained ANNs 46, 47, and 48, one of ordinary skill in the art will appreciate that trained ANNs 46, 47, and 48 may be included within optimization system 52. In such an embodiment, real-time data, and/or additional collected data may be added contemporaneous with the determination of optimized drilling parameters. Thus, while real-time optimization system 52 is determining optimized drilling parameters for one segments of a drill run, ANNs integral to system 52 may be updating the matrices in view of the newly acquired data. In so doing, the matrices may be updated for each segment of the drill run, thereby improving the optimization potential of real-time drilling system 52.

One of ordinary skill in the art will appreciate that the method as described above is an illustrative embodiment of how such a real-time drilling optimization system 52 that has access to trained ANNs may function, and as such, is not meant as a limitation on the present disclosure. Alternative embodiments may be foreseen wherein, for example, the entire drilling run is calculated instead of individual segments, only one instead of three trained ANNs is used, more than three ANNs are used, different ANNs are used, and/or additional studies are included when training the ANNs.

Additional methods and explanations for identifying design parameters, obtaining real-time data while drilling, and optimizing drilling parameters are included below to further expound the presently disclosed method.

Identifying Design Parameters for a Drilling Tool Assembly

Identifying design parameters for use in a drilling tool assembly may include the identification, simulation, and adjustment of components of, among other things, a drill string, drill bit, and/or BHA. The below described methods for identifying such design parameters for drill bits, drill strings, and/or BHAs may include examples of first studies, as described above, that may be used in accordance with embodiments of the present disclosure. Furthermore, multiple studies incorporating methods for drill bit, drill string, and/or BHA design optimization may be combined as multiple nodes of experience data for use in training, for example, ANNs. Thus, one of ordinary skill in the art will appreciate that the method for identifying design parameters for a drilling tool assembly described below is merely one method that may be used for collecting experience data.

In one aspect, the present disclosure provides a method for simulating the dynamic response of a drilling tool assembly drilling earth formation. Advantageously, this method takes into account interaction between the entire drilling tool assembly and the drilling environment. Interaction between the drilling tool assembly and the drilling environment may include interaction between the drill bit at the end of the drilling tool assembly and the formation at the bottom of the wellbore. Interaction between the drilling tool assembly and the drilling environment also may include interaction between the drilling tool assembly and the side (or wall) of the wellbore. Further, interaction between the drilling tool assembly and drilling environment may include viscous damping effects of the drilling fluid on the dynamic response of the drilling tool assembly.

A flow chart for one embodiment of the invention is illustrated in FIG. 5. The first step in this embodiment is selecting (defining or otherwise providing) parameters 100, including initial drilling tool assembly parameters 102, initial drilling environment parameters 104, drilling operating parameters 106, and drilling tool assembly/drilling environment interaction information (parameters and/or models) 108. The next step involves constructing a mechanics analysis model of the drilling tool assembly 110. The mechanics analysis model can be constructed using the drilling tool assembly parameters 102 and Newton's law of motion. The next step involves determining an initial static state of the drilling tool assembly 112 in the selected drilling environment using the mechanics analysis model 110 along with drilling environment parameters 104 and drilling tool assembly/drilling environment interaction information 108. Once the mechanics analysis model is constructed and an initial static state of the drill string is determined, the resulting static state parameters can be used with the drilling operating parameters 106 to incrementally solve for the dynamic response 114 of the drilling tool assembly 50 to rotational input from the rotary table 64 and the hook load provided at the hook 62. Once a simulated response for an increment in time (or for the total time) is obtained, results from the simulation can be provided as output 118, and used to generate a visual representation of drilling if desired.

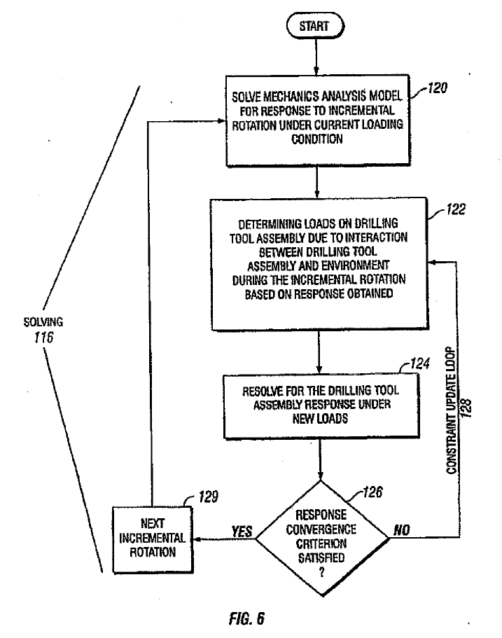

In one example, illustrated in FIG. 6, incrementally solving for the dynamic response (indicated as 116) may not only include solving the mechanics analysis model for the dynamic response to an incremental rotation, at 120, but may also include determining, from the response obtained, loads (e.g., drilling environment interaction forces) on the drilling tool assembly due to interaction between the drilling tool assembly and the drilling environment during the incremental rotation, at 122, and resolving for the response of the drilling tool assembly to the incremental rotation, at 124, under the newly determined loads. The determining and resolving may be repeated in a constraint update loop 128 until a response convergence criterion 126 is satisfied. Once a convergence criterion is satisfied, the entire incremental solving process 116 may be repeated for successive increments until an end condition for simulation is reached.

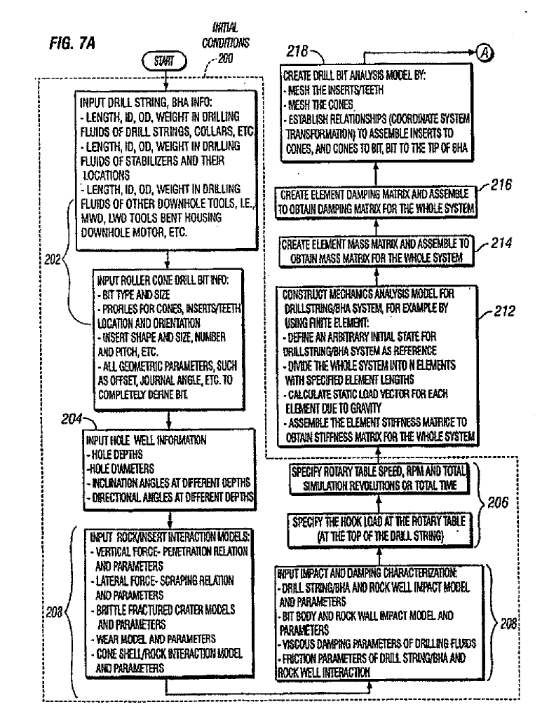

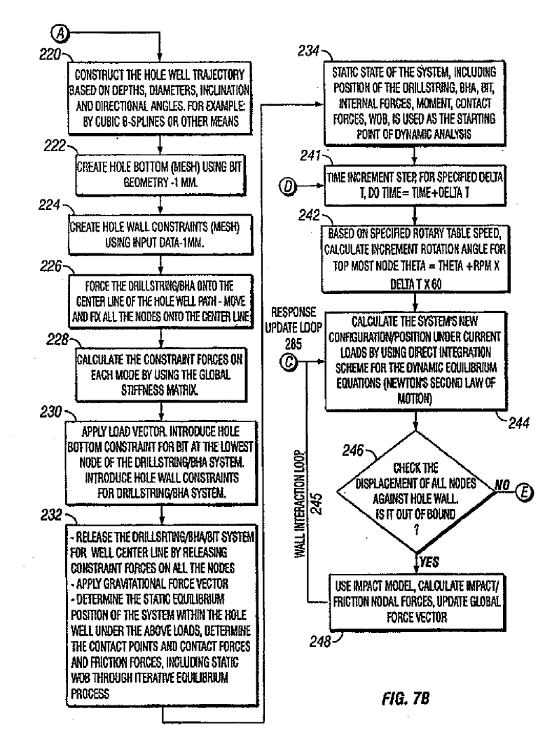

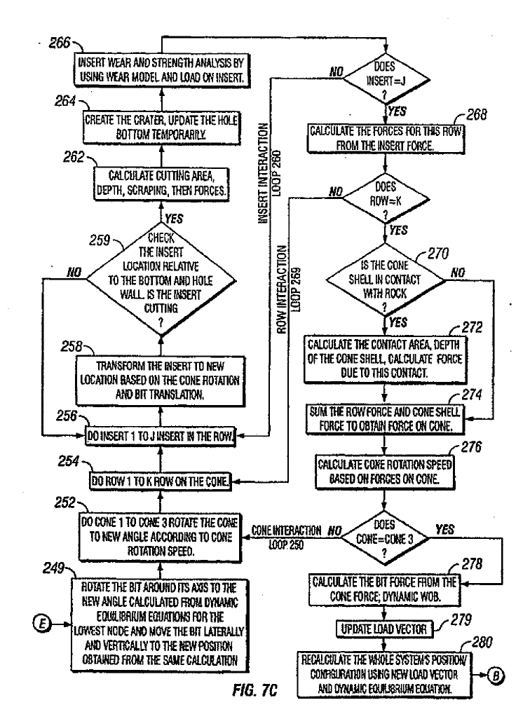

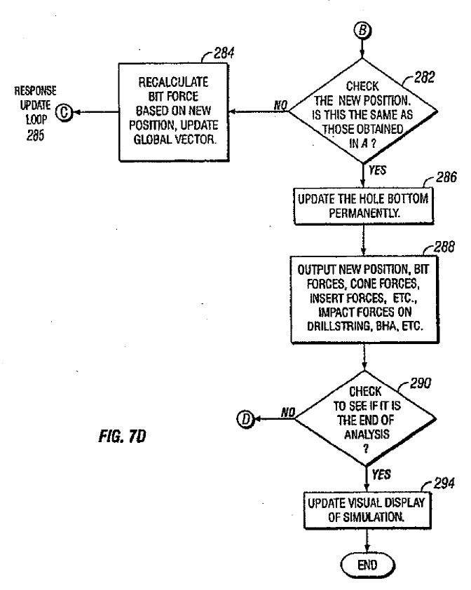

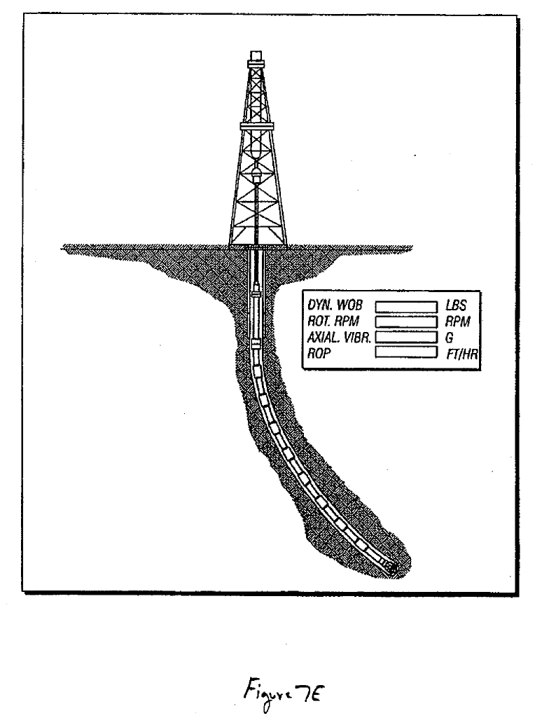

For the example shown in FIGS. 7A-D, the parameters provided as input 200 include drilling tool assembly design parameters 202, initial drilling environment parameters 204, drilling operating parameters 206, and drilling tool assembly/drilling environment interaction parameters and/or models 208.

Drilling tool assembly design parameters 202 may include drill string design parameters, BHA design parameters, and drill bit design parameters. In the example shown, the drill string comprises a plurality of joints of drill pipe, and the BHA comprises drill collars, stabilizers, bent housings, and other downhole tools (e.g., MWD tools, LWD tools, downhole motor, etc.), and a drill bit. As noted above, while the drill bit, generally, is considered a part of the BHA, in this example the design parameters of the drill bit are shown separately to illustrate that any type of drill bit may be defined and modeled using any drill bit analysis model.

Drill string design parameters include, for example, the length, inside diameter (ID), outside diameter (OD), weight (or density), and other material properties of the drill string in the aggregate. Alternatively, drill string design parameters may include the properties of each component of the drill string and the number of components and location of each component of the drill string. For example, the length, ID, OD, weight, and material properties of one joint of drill pipe may be provided along with the number of joints of drill pipe which make up the drill string. Material properties used may include the type of material and/or the strength, elasticity, and density of the material. The weight of the drill string, or individual components of the drill string, may be provided as “weight in drilling fluids” (the weight of the component when submerged in the selected drilling fluid).

BHA design parameters include, for example, the bent angle and orientation of the motor, the length, equivalent inside diameter (ID), outside diameter (OD), weight (or density), and other material properties of each of the various components of the BHA. In this example, the drill collars, stabilizers, and other downhole tools are defined by their lengths, equivalent IDs, ODs, material properties, weight in drilling fluids, and position in the drilling tool assembly.

The drill bit design parameters include, for example, the bit type (roller cone, fixed-cutter, etc.) and geometric parameters of the bit. Geometric parameters of the bit may include the bit size (e.g., diameter), number of cutting elements, and the location, shape, size, and orientation of the cutting elements. In the case of a roller cone bit, drill bit design parameters may further include cone profiles, cone axis offset (offset from perpendicular with the bit axis of rotation), the number of cutting elements on each cone, the location, size, shape, orientation, etc. of each cutting element on each cone, and any other bit geometric parameters (e.g., journal angles, element spacing, etc.) to completely define the bit geometry. In general, bit, cutting element, and cone geometry may be converted to coordinates and provided as input. One preferred method for obtaining bit design parameters is the use of 3-dimensional CAD solid or surface models to facilitate geometric input. Drill bit design parameters may further include material properties, such as strength, hardness, etc., of components of the bit.

Initial drilling environment parameters 204 include, for example, wellbore parameters. Wellbore parameters may include wellbore trajectory (or geometric) parameters and wellbore formation parameters. Wellbore trajectory parameters may include an initial wellbore measured depth (or length), wellbore diameter, inclination angle, and azimuth direction of the wellbore trajectory. In the typical case of a wellbore comprising segments having different diameters or differing in direction, the wellbore trajectory information may include depths, diameters, inclination angles, and azimuth directions for each of the various segments. Wellbore trajectory information may further include an indication of the curvature of the segments (which may be used to determine the order of mathematical equations used to represent each segment). Wellbore formation parameters may include the type of formation being drilled and/or material properties of the formation such as the formation strength, hardness, plasticity, and elastic modulus.

Drilling operating parameters 206, in this embodiment, include the rotary table speed at which the drilling tool assembly is rotated (RPM), the downhole motor speed if a downhole motor is included, and the hook load. Drilling operating parameters 206 may further include drilling fluid parameters, such as the viscosity and density of the drilling fluid, for example. It should be understood that drilling operating parameters 206 are not limited to these variables. In other embodiments, drilling operating parameters 206 may include other variables, such as, for example, rotary torque and drilling fluid flow rate. Additionally, drilling operating parameters 206 for the purpose of simulation may further include the total number of bit revolutions to be simulated or the total drilling time desired for simulation. However, it should be understood that total revolutions and total drilling time are simply end conditions that can be provided as input to control the stopping point of simulation, and are not necessary for the calculation required for simulation. Additionally, in other embodiments, other end conditions may be provided, such as total drilling depth to be simulated, or by operator command, for example.

Drilling tool assembly/drilling environment interaction information 208 includes, for example, cutting element/earth formation interaction models (or parameters) and drilling tool assembly/formation impact, friction, and damping models and/or parameters. Cutting element/earth formation interaction models may include vertical force-penetration relations and/or parameters which characterize the relationship between the axial force of a selected cutting element on a selected formation and the corresponding penetration of the cutting element into the formation. Cutting element/earth formation interaction models may also include lateral force-scraping relations and/or parameters which characterize the relationship between the lateral force of a selected cutting element on a selected formation and the corresponding scraping of the formation by the cutting element. Cutting element/formation interaction models may also include brittle fracture crater models and/or parameters for predicting formation craters which will likely result in brittle fracture, wear models and/or parameters for predicting cutting element wear resulting from contact with the formation, and cone shell/formation or bit body/formation interaction models and/or parameters for determining forces on the bit resulting from cone shell/formation or bit body/formation interaction. One example of methods for obtaining or determining drilling tool assembly/formation interaction models or parameters can be found in U.S. Pat. No. 6,516,293, assigned to the assignee of the present invention and incorporated herein by reference. Other methods for modeling drill bit interaction with a formation can be found in the previously noted SPE Papers No. 29922, No. 15617, and No. 15618, and PCT International Publication Nos. WO 00/12859 and WO 00/12860.

Drilling tool assembly/formation impact, friction, and damping models and/or parameters characterize impact and friction on the drilling tool assembly due to contact with the wall of the wellbore and the viscous damping effects of the drilling fluid. These models/parameters include, for example, drill string-BHA/formation impact models and/or parameters, bit body/formation impact models and/or parameters, drill string-BHA/formation friction models and/or parameters, and drilling fluid viscous damping models and/or parameters. One skilled in the art will appreciate that impact, friction and damping models/parameters may be obtained through laboratory experimentation, in a method similar to that disclosed in the prior art for drill bits interaction models/parameters. Alternatively, these models may also be derived based on mechanical properties of the formation and the drilling tool assembly, or may be obtained from literature. Prior art methods for determining impact and friction models are shown, for example, in papers such as the one by Yu Wang and Matthew Mason, entitled “Two-Dimensional Rigid-Body Collisions with Friction”, Journal of Applied Mechanics, September 1992, Vol. 59, pp. 635-642.

As shown in FIGS. 7A-D, once input parameters/models 200 are selected, determined, or otherwise provided, a two-part mechanics analysis model of the drilling tool assembly is constructed and used to determine the initial static state (at 232) of the drilling tool assembly in the wellbore. The first part of the mechanics analysis model takes into consideration the overall structure of the drilling tool assembly, with the drill bit being only generally represented. In this embodiment, for example, a finite element method is used (generally described at 212) wherein an arbitrary initial state (such as hanging in the vertical mode free of bending stresses) is defined for the drilling tool assembly as a reference and the drilling tool assembly is divided into N elements of specified element lengths (i.e., meshed). The static load vector for each element due to gravity is calculated. Then element stiffness matrices are constructed based on the material properties (e.g., elasticity), element length, and cross sectional geometrical properties of drilling tool assembly components provided as input and are used to construct a stiffness matrix, at 212, for the entire drilling tool assembly (wherein the drill bit is generally represented by a single node). Similarly, element mass matrices are constructed by determining the mass of each element (based on material properties, etc.) and are used to construct a mass matrix, at 214, for the entire drilling tool assembly. Additionally, element damping matrices can be constructed (based on experimental data, approximation, or other method) and used to construct a damping matrix, at 216, for the entire drilling tool assembly. Methods for dividing a system into finite elements and constructing corresponding stiffness, mass, and damping matrices are known in the art and thus are not explained in detail here. Examples of such methods are shown, for example, in “Finite Elements for Analysis and Design” by J. E. Akin (Academic Press, 1994).

The second part of the mechanics analysis model of the drilling tool assembly is a mechanics analysis model of the drill bit which takes into account details of selected drill bit design. The drill bit mechanics analysis model is constructed by creating a mesh of the cutting elements and cones (for a roller cone bit) of the bit, and establishing a coordinate relationship (coordinate system transformation) between the cutting elements and the cones, between the cones and the bit, and between the bit and the tip of the BHA. As previously noted, examples of methods for constructing mechanics analysis models for roller cone drill bits can be found in U.S. Pat. No. 6,516,293, as well as SPE Paper No. 29922, and PCT International Publication Nos. WO 00/12859 and WO 00/12860, noted above.

Because the response of the drilling tool assembly is subject to the constraint within the wellbore, wellbore constraints for the drilling tool assembly are determined, at 222, 224. First, the trajectory of the wall of the wellbore, which constrains the drilling tool assembly and forces it to conform to the wellbore path, is constructed at 220 using wellbore trajectory parameters provided as input at 204. For example, a cubic B-spline method or other interpolation method can be used to approximate wellbore wall coordinates at depths between the depths provided as input data. The wall coordinates are then discretized (or meshed), at 224 and stored. Similarly, an initial wellbore bottom surface geometry, which is either selected or determined, may also be discretized, at 222, and stored. The initial bottom surface of the wellbore may be selected as flat or as any other contour, which may be provided as wellbore input at 204 or 222. Alternatively, the initial bottom surface geometry may be generated or approximated based on the selected bit geometry. For example, the initial bottomhole geometry may be selected from a “library” (i.e., database) containing stored bottomhole geometries resulting from the use of various bits.

In this embodiment, a coordinate mesh size of 1 millimeter is selected for the wellbore surfaces (wall and bottomhole); however, the coordinate mesh size is not intended to be a limitation on the invention. Once meshed and stored, the wellbore wall and bottomhole geometry, together, comprise the initial wellbore constraints within which the drilling tool assembly must operate, thus, within which the drilling tool assembly response must be constrained.

As shown in FIGS. 7A-D, once the (two-part) mechanics analysis model for the drilling tool assembly is constructed (using Newton's second law) and the wellbore constraints are specified 222, 224, the mechanics model and constraints can be used to determine the constraint forces on the drilling tool assembly when forced to the wellbore trajectory and bottomhole from its original “stress free” state. In this embodiment, the constraint forces on the drilling tool assembly are determined by first displacing and fixing the nodes of the drilling tool assembly so the centerline of the drilling tool assembly corresponds to the centerline of the wellbore, at 226. Then, the corresponding constraining forces required on each node (to fix it in this position) are calculated at 228 from the fixed nodal displacements using the drilling tool assembly (i.e., system or global) stiffness matrix from 212. Once the “centerline” constraining forces are determined, the hook load is specified, and initial wellbore wall constraints and bottomhole constraints are introduced at 230 along the drilling tool assembly and at the bit (lowest node). The centerline constraints are used as the wellbore wall constraints. The hook load and gravitational force vector are used to determine the WOB.

As previously noted, the hook load is the load measured at the hook from which the drilling tool assembly is suspended. Because the weight of the drilling tool assembly is known, the bottomhole constraint force (i.e., WOB) can be determined as the weight of the drilling tool assembly minus the hook load and the frictional forces and reaction forces of the hole wall on the drilling tool assembly.

Once the initial loading conditions are introduced, the “centerline” constraint forces on all of the nodes are removed, a gravitational force vector is applied, and the static equilibrium position of the assembly within the wellbore is determined by iteratively calculating the static state of the drilling tool assembly 232. Iterations are necessary because the contact points for each iteration may be different. The convergent static equilibrium state is reached and the iteration process ends when the contact points and, hence, contact forces are substantially the same for two successive iterations. Along with the static equilibrium position, the contact points, contact forces, friction forces, and static WOB on the drilling tool assembly are determined. Once the static state of the system is obtained (at 232) it can be used as the staring point (initial condition) 234 for simulation of the dynamic response of the drilling tool assembly drilling earth formation.

As shown in FIGS. 7A-D, once input data are provided and the static state of the drilling tool assembly in the wellbore is determined, calculations in the dynamic response simulation loop may be carried out. Briefly summarizing the functions performed in the dynamic response loop, the drilling tool assembly drilling earth formation is simulated by “rotating” the top of the drilling tool assembly (and the downhole motor, if used) through an incremental angle (at 242), and then calculating the response of the drilling tool assembly under the previously determined loading conditions 244 to the rotation(s). The constraint loads on the drilling tool assembly resulting from interaction with the wellbore wall during the incremental rotation are iteratively determined (in loop 245) and are used to update the drilling tool assembly constraint loads (i.e., global load vector), at 248, and the response is recalculated under the updated loading condition. The new response is then rechecked to determine if wall constraint loads have changed and, if necessary, wall constraint loads are re-determined, the load vector updated, and a new response calculated. Then the bottomhole constraint loads resulting from bit interaction with the formation during the incremental rotation are evaluated based on the new response (loop 252), the load vector is updated (at 279), and a new response is calculated (at 280). The wall and bottomhole constraint forces are repeatedly updated (in loop 285) until convergence of a dynamic response solution is determined (i.e., changes in the wall constraints and bottomhole constraints for consecutive solutions are determined to be negligible). The entire dynamic simulation loop is then repeated for successive incremental rotations until an end condition of the simulation is reached (at 290) or until simulation is otherwise terminated. A more detailed description of the elements in the simulation loop follows.

Prior to the start of the simulation loop, drilling operating parameters 206 are specified. As previously noted, the drilling operating parameters 206 include the rotary table speed, downhole motor speed (if included in the BHA), and the hook load. In this example, the end condition for simulation is also provided at 204, as either the total number of revolutions to be simulated or the total time for the simulation. Additionally, the incremental step desired for calculations should be defined, selected, or otherwise provided. In the embodiment shown, an incremental time step of Δt=10⁻³ seconds is selected. However, it should be understood that the incremental time step is not intended to be a limitation on the invention.

Once the static state of the system is known (from 232) and the operational parameters are provided, the dynamic response simulation loop 240 can begin. In the first step of the simulation loop 240, the current time increment is calculated at 241, wherein tᵢ₊₁=tᵢ+Δt. Then, the incremental rotation which occurs during that time increment is calculated, at 242. In this embodiment, the formula used to calculate an incremental rotation angle at time tᵢ₊₁ is θᵢ₊₁=θᵢ+RPM*Δt*60, wherein RPM is the rotational speed (in RPM) of the rotary table provided as input data (at 204). The calculated incremental rotation angle is applied proximal to the top of the drilling tool assembly (at the node(s) corresponding to the position of the rotary table). If a downhole motor is included in the BHA, the downhole motor incremental rotation is also calculated and applied to the corresponding nodes.

Once the incremental rotation angle and current time are determined, the system's new configuration (nodal positions) under the extant loads and the incremental rotation is calculated (at 244) using mechanics analysis model modified to include the rotational input as an excitation. For example, a direct integration scheme can be used to solve the resulting dynamic equilibrium equations (modified mechanics analysis model) for the drilling tool assembly. The dynamic equilibrium equation (like the mechanics analysis equation) can be derived using Newton's second law of motion, wherein the constructed drilling tool assembly mass, stiffness, and damping matrices along with the calculated static equilibrium load vector can be used to determine the response to the incremental rotation. For the example shown in FIGS. 7A-D, it should be understood that at the first time increment ti the extant loads on the system are the static equilibrium loads (calculated for to) which include the static state WOB and the constraint loads resulting from drilling tool assembly contact with the wall and bottom of the wellbore.

As the drilling tool assembly is incrementally “rotated”, constraint loads acting on the bit may change. For example, points of the drilling tool assembly in contact with the borehole surface prior to rotation may be moved along the surface of the wellbore resulting in friction forces at those points. Similarly, some points of the drilling tool assembly, which were nearly in contact with the borehole surface prior to the incremental rotation, may be brought into contact with the formation as a result of the incremental rotation, resulting in impact forces on the drilling tool assembly at those locations. As shown in FIGS. 7A-D, changes in the constraint loads resulting from the incremental rotation of the drilling tool assembly can be accounted for in the wall interaction update loop 245.

In this example, once the system's response (i.e., new configuration) under the current loading conditions is obtained, the positions of the nodes in the new configuration are checked (at 244) in the wall constraint loop 245 to determine whether any nodal displacements fall outside of the bounds (i.e., violate constraint conditions) defined by the wellbore wall. If nodes are found to have moved outside of the wellbore wall, the impact and/or friction forces which would have occurred due to contact with the wellbore wall are approximated for those nodes (at 248) using the impact and/or friction models or parameters provided as input at 208. Then the global load vector for the drilling tool assembly is updated (also shown at 208) to reflect the newly determined constraint loads. Constraint loads to be calculated may be determined to result from impact if, prior to the incremental rotation, the node was not in contact with the wellbore wall. Similarly, the constraint load can be determined to result from frictional drag if the node now in contact with the wellbore wall was also in contact with the wall prior to the incremental rotation. Once the new constraint loads are determined and the global load vector is updated, at 248, the drilling tool assembly response is recalculated (at 244) for the same incremental rotation under the newly updated load vector (as indicated by loop 245). The nodal displacements are then rechecked (at 246) and the wall interaction update loop 245 is repeated until a dynamic response within the wellbore constraints is obtained.

Once a dynamic response conforming to the borehole wall constraints is determined for the incremental rotation, the constraint loads on the drilling tool assembly due to interaction with the bottomhole during the incremental rotation are determined in the cone interaction loop 250. Those skilled in the art will appreciate that any method for modeling drill bit/earth formation interaction during drilling may be used to determine the forces acting on the drill bit during the incremental rotation of the drilling tool assembly. An example of one method is illustrated in the cone interaction loop 250 in FIGS. 7A-D.

In the cons interaction loop 250, the mechanics analysis model of the drill bit is subjected to the incremental rotation angle calculated for the lowest node of the drilling tool assembly, and is then moved laterally and vertically to the new position obtained from the same calculation, as shown at 249. As previously noted, the drill bit in this example is a roller cone drill bit. Thus, in this example, once the bit rotation and new bit position are determined, interaction between each cone and the formation is determined. For a first cone, an incremental cone rotation angle is calculated at 252 based on a calculated incremental cone rotation speed and used to determine the movement of the cone during the incremental rotation. It should be understood that the incremental cone rotation speed can be determined from all the forces acting on the cutting elements of the cone and Newton's second law of motion. Alternatively, it may be approximated from the rotation speed of the bit and the effective radius of the “drive row” of the cone. The effective radius is generally related to the lateral extent of the cutting elements that extend the farthest from the axis of rotation of the cone. Thus, the rotation speed of the cone can be defined or calculated based on the calculated bit rotational speed and the defined geometry of the cone provided as input (e.g., the cone diameter profile, cone axial offset, etc).

Then, for the first cone, interaction between each cutting element and the earth formation is determined in the cutting element/formation interaction loop 256. In this interaction loop 256, the new position of a cutting element, for example, cutting element j on row k, is calculated 258 based on the incremental cone rotation and bit rotation and translation. Then, the location of cutting element j/k relative to the bottomhole and wall of the wellbore is evaluated, at 259, to determine whether cutting element interference (or contact) with the formation occurred during the incremental rotation of the bit. If it is determined that contact did not occur, then the next cutting element is analyzed and the interaction evaluation is repeated for the next cutting element. If contact is determined to have occurred, then a depth of penetration, interference projection area, and scraping distance of the cutting element in the formation are determined, at 262, based on the next movement of the cutting element during the incremental rotation. The depth of penetration is the distance from the earth formation surface a cutting element penetrates into the earth formation. Depth of penetration can range from zero (no penetration) to the full height of the cutting element (full penetration). Interference projection area is the fractional amount of the cutting element surface area, corresponding to the depth of penetration, which actually contacts the earth formation. A fractional amount of contact usually occurs due to craters in the formation formed from previous contact with cutting elements. Scraping distance takes into account the movement of the cutting element in the formation during the incremental rotation. Once the depth of penetration, interference projection area, and scraping distance are determined for cutting element j,k these parameters are used in conjunction with the cutting element/formation interaction data to determine the resulting forces (constraint forces) exerted on the cutting element by the earth formation (also indicated at 262). For example, force may be determined using the relationship disclosed in U.S. Pat. No. 6,516,293, noted above and incorporated herein by reference.

Once the cutting element/formation interaction variables (area, depth, force, etc.) are determined for cutting element j,k, the geometry of the bottom surface of the wellbore can be temporarily updated, at 264, to reflect the removal of formation by cutting element j,k during the incremental rotation of the drill bit. The actual size of the crater resulting from cutting element contact with the formation can be determined from the cutting element/earth formation interaction data based on the bottomhole surface geometry, and the forces exerted by the cutting element. One such procedure is described in U.S. Pat. No. 6,516,293, noted above.

After the bottomhole geometry is temporarily updated, insert wear and strength can also be analyzed, as shown at 270, based on wear models and calculated loads on the cutting elements to determine wear on the cutting elements resulting from contact with the formation and the resulting reduction in cutting element strength. Then, the cutting element/formation interaction loop 260 calculations are repeated for the next cutting element (i=j+1) of row k until cutting element/formation interaction for each cutting element of the row is determined.

Once the forces on each cutting element of a row are determined, the total forces on that row are calculated (at 268) as a sum of all the forces on the cutting elements of that row. Then, the cutting element/earth formation interaction calculations are repeated for the next row on the cone (k=k+1) (in the row interaction loop 269) until the forces on each of the cutting elements on each of the rows on that cone are obtained. Once interaction of all of the cutting elements on a cone is determined, cone shell interaction with the formation is determined by checking node displacements at the cone surface, at 270, to determine if any of the nodes are out of bounds with respect to (or make contact with) the wellbore wall or bottomhole surface. If cone shell contact is determined to have occurred for the cone during the incremental rotation, the contact area and depth of penetration of the cone shell are determined (at 272) and used to determine interaction forces on the cone shell resulting from the contact.

Once forces resulting from cone shell contact with the formation during the incremental rotation are determined, or it is determined that no shell contact has occurred, the total interaction forces on the cone during the incremental rotation can be calculated by summing all of the row forces and any cone shell forces on the cone, at 274. The total forces acting on the cone during the incremental rotation may then be used to calculate the incremental cone rotation speed \dot{θ}ₜ, at 276. Cone interaction calculations are then repeated for each cone (l=l+1) until the forces, rotation speed, etc. on each of the cones of the bit due to interaction with the formation are determined.

Once the interaction forces on each cone are determined, the total axial force on the bit (dynamic WOB) during the incremental rotation of the drilling tool assembly is calculated 278, from the cone forces. The newly calculated bit interaction forces are then used to update the global load vector (at 279), and the response of the drilling tool assembly is recalculated (at 280) under the updated loading condition. The newly calculated response is then compared to the previous response (at 282) to determine if the responses are substantially similar. If the responses are determined to be substantially similar, then the newly calculated response is considered to have converged to a correct solution. However, if the responses are not determined to be substantially similar, then the bit interaction forces are recalculated based on the latest response at 284 and the global load vector is again updated (as indicated at 284). Then, a new response is calculated by repeating the entire response calculation (including the wellbore wall constraint update and drill bit interaction force update) until consecutive responses are obtained which are determined to be substantially similar (indicated by loop 285), thereby indicating convergence to the solution for dynamic response to the incremental rotation.

Once the dynamic response of the drilling tool assembly to an incremental rotation is obtained from the response force update loop 285, the bottomhole surface geometry is then permanently updated (at 286) to reflect the removal of formation corresponding to the solution. At this point, output information desired from the incremental simulation step can be provided as output or stored. For example, the new position of the drilling tool assembly, the dynamic WOB, cone forces, cutting element forces, impact forces, friction forces, may be provided as output information or stored.

This dynamic response simulation loop 240 as described above is then repeated for successive incremental rotations of the bit until an end condition of the simulation (checked at 290) is satisfied. For example, using the total number of bit revolutions to be simulated as the termination command, the incremental rotation of the drilling tool assembly and subsequent iterative calculations of the dynamic response simulation loop 240 will be repeated until the selected total number of revolutions to be simulated is reached. Repeating the dynamic response simulation loop 240 as described above will result in simulating the performance of an entire drilling tool assembly drilling earth formations with continuous updates of the bottomhole pattern as drilled, thereby simulating the drilling of the drilling tool assembly in the selected earth formation. Upon completion of a selected number of operations of the dynamic response simulation loop, results of the simulation may be used to generate output information at 294 characterizing the performance of the drilling tool assembly drilling the selected earth formation under the selected drilling conditions, as shown in FIGS. 7A-D. It should be understood that the simulation can be stopped using any other suitable termination indicator, such as a selected wellbore depth desired to be drilled, indicated divergence of a solution, etc.

As noted above, output information from a dynamic simulation of a drilling tool assembly drilling an earth formation may include, for example, the drilling tool assembly configuration (or response) obtained for each time increment, and corresponding bit forces, cone forces, cutting element forces, impact forces, friction forces, dynamic WOB, resulting bottomhole geometry, etc. This output information may be presented in the form of a visual representation (indicated at 294), such as a visual representation of the borehole being drilled through the earth formation with continuous updated bottomhole geometries and the dynamic response of the drilling tool assembly to drilling presented on a computer screen. Alternatively, the visual representation may include graphs of parameters provided as input and/or calculated during the simulation. For example, a time history of the dynamic WOB or the wear of cutting elements during drilling may be presented as a graphic display on a computer screen. It should be understood that the invention is not limited to any particular type of display. Further, the means used for visually displaying aspects of simulated drilling is a matter of convenience for the system designer, and is not intended to limit the present disclosure. One example of output information converted to a visual representation is illustrated in FIG. 7E, wherein the rotation of the drilling tool assembly and corresponding drilling of the formation is graphically illustrated as a visual display of drilling and desired parameters calculated during drilling can be numerically displayed.

The example described above represents only one embodiment of the present disclosure. Those skilled in the art will appreciate that other embodiments can be devised which do not depart from the scope of the disclosure as described herein. For example, an alternative method can be used to account for changes in constraint forces during incremental rotation. For example, instead of using a finite element method, a finite difference method or a weighted residual method can be used to model the drilling tool assembly. Similarly, other methods may be used to predict the forces exerted on the bit as a result of bit/cutting element interaction with the bottomhole surface. For example, in one case, a method for interpolating between calculated values of constraint forces may be used to predict the constraint forces on the drilling tool assembly or a different method of predicting the value of the constraint forces resulting from impact or frictional contact may be used. Further, a modified version of the method described above for predicting forces resulting from cutting element interaction with the bottomhole surface may be used. These methods may be analytical, numerical (such as finite element method), or experimental. Alternatively, methods such as disclosed in SPE Paper No. 29922 noted above or PCT Patent Application Nos. WO 00/12859 and WO 00/12860 may be used to model roller cone drill bit interaction with the bottomhole surface, or methods such as disclosed in SPE papers no. 15617 and no. 15618 noted above may be used to model fixed-cutter bit interaction with the bottomhole surface if a fixed-cutter bit is used.

One of ordinary skill in the art will appreciate that the above described method of identifying design parameters for a drilling tool assembly may provide experience data useful in the training of ANNs. However, the above described method is merely exemplary, and is not intended as a limitation on the type of program that may provide experience data. Thus, in certain embodiments, multiple drilling tool assembly design methods may be combined to provide a plurality of sources of experience data, while in other embodiments, experience data may include a single source of drilling tool assembly design data.

Method for Obtaining Real-Time Data While Drilling

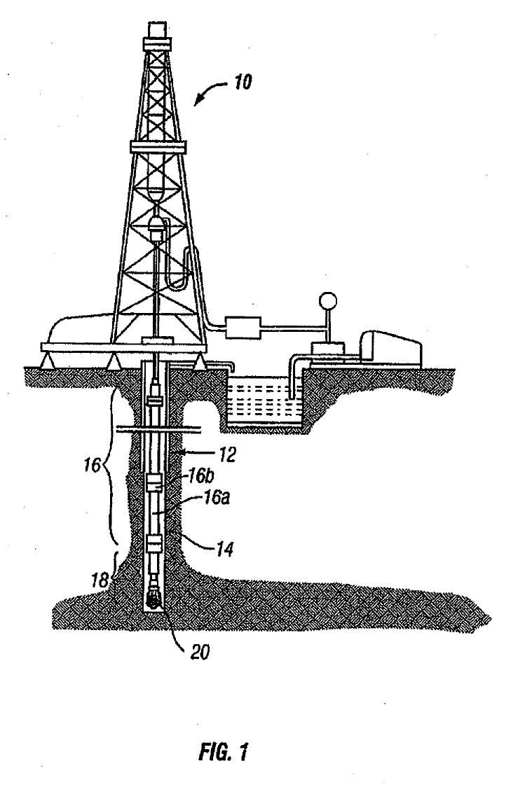

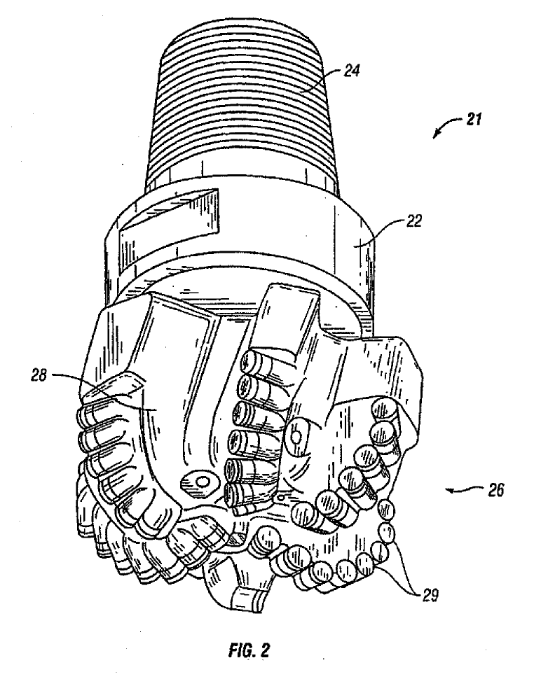

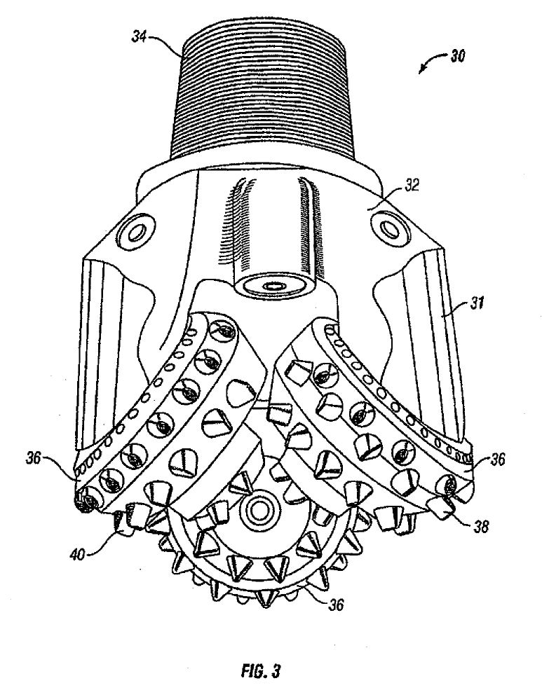

Referring back to FIG. 1, a drill string 12 typically includes a BHA 18 that includes a drill bit 20 and a number of downhole tools (e.g., tools 14 and 16). Downhole tools may include various sensors for measuring the properties related to the formation and its contents, as well as properties related to the borehole conditions and the drill bit In general, “logging-while-drilling” (“LWD”) refers to measurements related to the formation and its contents. “Measurement-while-drilling” (“MWD”), on the other hand, refers to measurements related to the borehole and the drill bit. The distinction is not germane to the present disclosure, and any reference to one should not be interpreted to exclude the other.

LWD sensors located in a BHA 18 may include, for example, one or more of a gamma ray tool, a resistivity tool, an NMR tool, a sonic tool, a formation sampling tool, a neutron tool, and electrical tools. Such tools are used to measure properties of the formation and its contents, such as, the formation porosity, density, lithology, dielectric constant, formation layer interfaces, as well as the type, pressure, and permeability of the fluid in the formation.

One or more MWD sensors may also be located in a BHA 18. MWD sensors may measure the loads acting on the drill string, such a WOB, TOB, and bending moments. It is also desirable to measure the axial, lateral, and torsional vibrations in the drill string. Other MWD sensors may measure the azimuth and inclination of the drill bit, the temperature and pressure of the fluids in the borehole, as well as properties of the drill bit such as bearing temperature and grease pressure.

The data collected by LWD/MWD tools is often relayed to the surface before being used. In some cases, the data is simply stored in a memory in the tool and retrieved when the tool it brought back to the surface. In other cases, LWD/MWD data may be transmitted to the surface using known telemetry methods.

Telemetry between the BHA and the surface, such as mud-pulse telemetry, is typically slow and only enables the transmission of selected information. Because of the slow telemetry rate, the data from LWD/MWD may not be available at the surface for several minutes after the data have been collected. In addition, the sensors in a typical BHA 18 are located behind the drill bit, in some cases by as much as fifty feet. Thus, the data received at the surface may be slightly delayed due to the telemetry rate that the position of the sensors in the BHA.

Other measurements are made based on lagged events. For example, drill cuttings in the return mud are typically analyzed to gain more information about the formation that has been drilled. During the drilling process, the drill cuttings are transported to the surface in the mud flow in through the annulus between the drill string 12 and the borehole 14. In a deep well, for example, the drill bit 20 may drill an additional 50 to 100 feet while a particular fragment of drill cuttings travels to the surface. Thus, the drill bit continues to advance an additional distance, while the drilled cuttings from the depth position of interest are transported to the surface in the mud circulation system. The data is lagged by at least the time to circulate the cuttings to surface.

Analysis of the drill cuttings and the return mud provides additional information about the formation and its contents. For example, the formation lithology, compressive strength, shear strength, abrasiveness, and conductivity may be measured. Measurements of the return mud temperature, density, and gas content may also yield data related to the formation and its contents.

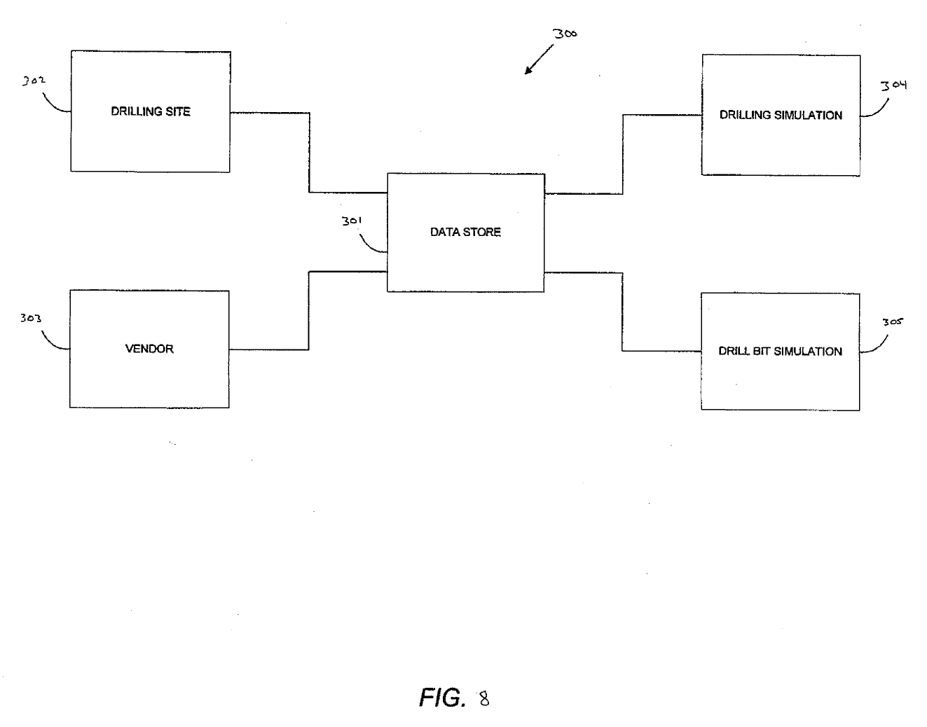

FIG. 8 shows a schematic of drilling communications system 300. The drilling system, including the drilling rig and other equipment at the drilling site 302, is connected to a remote data store 301. As data is collected at the drilling site 302, the data is transmitted to the data store 301.

The remote data store 301 may be any database for storing data. For example, any commercially available database may be used. In addition, a database may be developed for the particular purpose of storing drilling data without departing from the scope of the present disclosure. In one embodiment, the remote data store uses a WITSML (Wellsite Information Transfer Standard) data transfer standard. Other transfer standards may also be used without departing from the scope of the present disclosure.

The drilling site 302 may be connected to the data store 301 via an internet connection. Such a connection enables the data store 301 to be in a location remote from the drilling site 302. The data store 301 is preferably located on a secure server to prevent unauthorized access. Other types of communication connections may be used without departing from the scope of the present disclosure.

Other party connections to the data store 301 may include an oilfield services vendor(s) 303, a drilling optimization service, and third party and remote users. In some embodiments, each of the different parties that have access to the data store 301 is in different locations. In practice, oilfield service vendors 303 are typically located at the drilling site 302, but they are shown separately because vendors 303 represent a separate party having access to the data store 301. In addition, the present disclosure does not preclude a vendor 303 from transmitting the LWD/MWD measurement data to a separate site for analysis before the data are uploaded to the data store 301.

In addition to having a data store 301 located on a secure server, in some embodiments, each of the parties connected to the data store 301 has access to view and update only specific portions of the data in the data store 301. For example, a vendor 303 may be restricted such that they cannot upload data related to drill cutting analysis, a measurement which is typically not performed by vendor 303.

As measurement data becomes available, it may be uploaded to the data store 301. The data may be correlated to the particular position in the wellbore to which the data relate, a particular time stamp when the measurement was taken, or both. The normal rig sensed data (e.g., WOB, TOB, RPM, etc.) will generally relate to the drill bit position in the wellbore that is presently being drilled. As this data is uploaded to the data store 301, it will typically be correlated to the position of the drill bit when the data was recorded or measured.

Vendor data (e.g., data from LWD/MWD instruments), as discussed above, may be slightly delayed. Because of the position of the sensors relative to the drill bit and the delay in the telemetry process, vendor data may not relate to the current position of the drill bit when the data become available. Still, the delayed data will typically be correlated to a specific position in the wellbore when it was measured and then is uploaded to the data store 301. It is noted that the particular wellbore position to which vendor data are correlated may be many feet behind the current drill bit position when the data become available.

In some embodiments, the vendor data may be used to verify or update rig sensed data that has been previously recorded. For example, one type of MWD sensor that is often included in a BHA is a load cell or a load sensor. Such sensors measure the loads, such as WOB and TOB, which are acting on the drillstring near the bottom of the borehole. Because data from near the drill bit will more closely represent the actual drilling conditions, the vendor data may be used to update or verify similar measurements made on the rig. One possible cause for a discrepancy in such data is that the drill string may encounter friction against the borehole wall. When this occurs, the WOB and TOB measured at the surface will tend to be higher that the actual WOB and TOB experienced at the drill bit.

The process of drilling a well typically includes several “trips” of the drill string. A “trip” is when the entire drill string is removed from the well to, for example, replace the drill bit or other equipment in the BHA. When the drill string is tripped, it is common practice to lower one or more “wireline” tools into the well to investigate the formations that have already been drilled. Typically wireline tool measurements are performed by an oilfield services vendor.

Wireline tools enable the use of sensors and instruments that may not have been included in the BHA. In addition, the wire that is used to lower the tool into the well may be used for data communications at much faster rates that are possible with telemetry methods used while drilling. Data obtained through the use of wireline tools may be uploaded to the data store so that the data may be used in future optimization methods performed for the current well, once drilling recommences.

As was mentioned above, it is often the case that some of the LWD/MWD data that is collected may not be transmitted to the surface due to constraints in the telemetry system. Nonetheless, it is common practice to store the data in a memory in the downhole tool. When the BHA is removed from the well during a trip of the drill string, a surface computer may be connected to the BHA sensors and instruments to obtain all of the data that was gathered. As with wireline data, this newly collected LWD/MWD data may be uploaded to the data store for use in the continuous or future optimization methods for the current well.

Similar to vendor data, data from lagged events may also be correlated to the position in the wellbore to which the data relate. Because the data is lagged, the correlated position will be a position many feet above the current position of the drill bit when the data becomes available and is uploaded to the data store 301. For example, data gained through the analysis of drill cuttings may be correlated to the position in the wellbore where the cuttings were produced. By the time such data becomes available, the drill bit may have drilled many additional feet.

As with certain types of vendor data, some lagged data may be used to update or verify previously obtained data. For example, analysis of drill cuttings may yield data related to the porosity or lithology of the formation. Such data may be used to update or verify vendor data that is related to the same properties. In addition, some types of downhole measurements are dependent of two or more properties. Narrowing the possible values for porosity, for example, may yield better results for other formation properties. The newly available data, as well as data updated from lagged events, may then be used in future optimization methods.

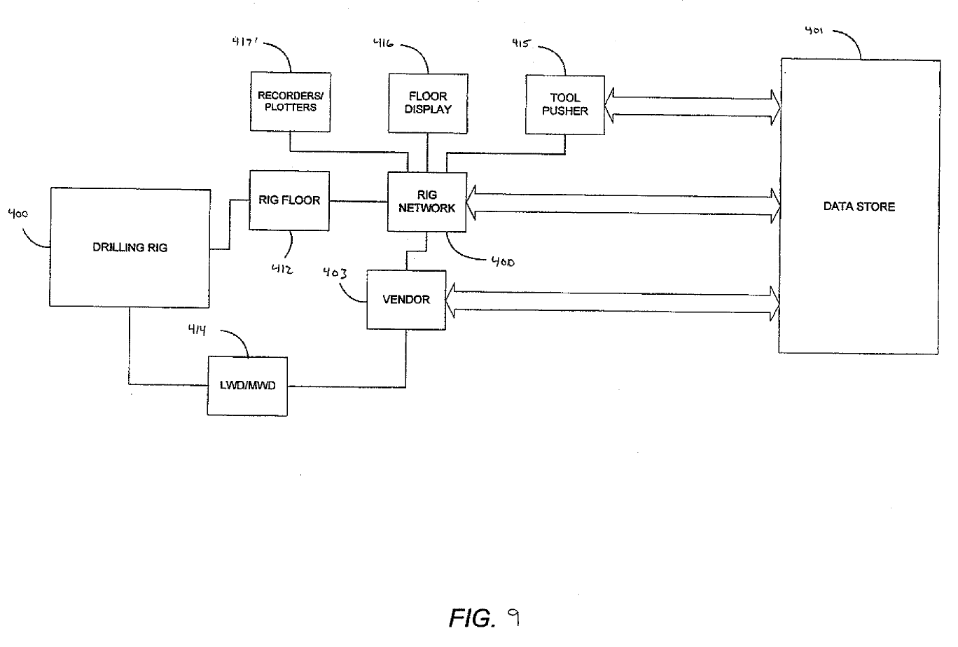

In the example shown in FIG. 9, a rig network 400 is connected to a remote data store 401. The remote data store 401 may be located apart from the drilling site. For example, the rig network may be connected to the data store 401 through a secure internet connection. In addition to the rig network 400, other users may also be connected to the data store 401. For example, a tool pusher 415 or company man may be connected to the data store so that data may be directly queried from the data store 401. Also, a vendor 403 may be connected to the data store 401 so that vendor data may be uploaded to the data store 401 as soon as it becomes available.

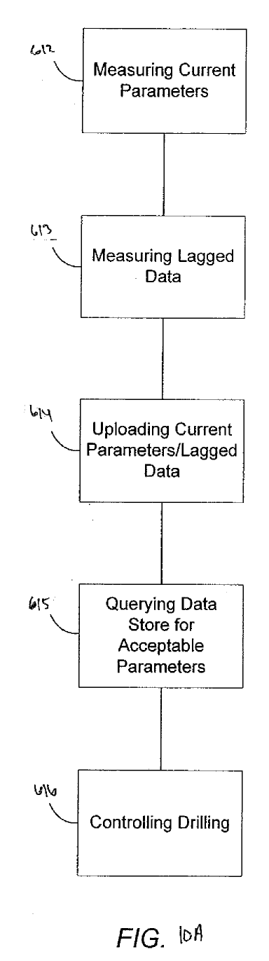

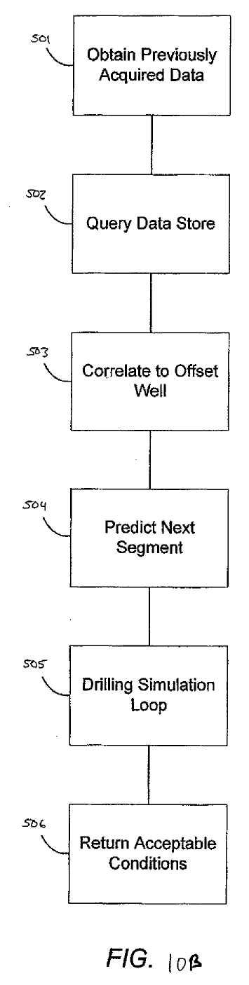

FIG. 10A shows a method of drilling, in accordance with one aspect of the present disclosure. The method first includes measuring current drilling parameters at 612. This is the rig-sensed data, including WOB, TOB, RPM, etc. In some embodiments, the method also includes measuring the lagged data, such as a return mud analysis at 613. This step may not be included in all embodiments.

The method includes uploading the current parameters and the lagged data to a remote data store at 614. The data may then be queried from the remote data store for analysis by a drilling simulation service. The method may also include querying the remote data store for a set of acceptable drilling parameters for the next segment at 615. In some embodiments, the acceptable parameters are returned to the data store by a drilling simulation service. In some cases, querying the remote data store for the acceptable parameters include querying the acceptable parameters for the remainder of the run to the target depth.

The method may then include controlling the drilling in accordance with the acceptable drilling parameters at 616. In some embodiments, this is performed by a driller. In other embodiments, the drilling is performed by an automated drilling system, and controlling the drilling in accordance with the acceptable parameters is performed by the automated drilling system.

FIG. 10B shows a method in accordance with the disclosure for optimizing drilling parameters in real-time. In one or more embodiments, the method is performed by a drilling optimization service. One such service, called DBOS™, is offered by Smith International, Inc., the assignee of the entire right of the present application. A method for optimizing drilling parameters may be performed at a location that is remote from the drilling site. A remote data store may also be at any location. It is within the scope of the present disclosure for a data store to be located at the drilling site or at the same location where the method for optimizing drilling parameters is being performed. In some embodiments, the data store is remote from at least one, if not both, of the drilling site and the location of the drilling parameter optimization.

The method includes obtaining previously acquired data, at step 501. In some embodiments, the previously acquired data is known before the current well is drilled. Thus, the data may be provided to a drilling optimization service before the current well is drilled. In other embodiments, the previously acquired data may be stored in a data store, and the previously acquired data may be queried from the data store—either separately or together with the current well data.

The method includes querying the data store to get the current well data, at step 502. In some embodiments, querying the current well data includes obtaining all of the data that is available for the current well. In other embodiments, querying the current well data includes obtaining only certain data that are specifically desired.

The current well data that is queried may include any data related to the current well, the formations through which the current well passes and their contents, as well as data related to the drill bit and other drilling conditions. For example, current well data may include the type, design, and size of the drill bit that is being used to drill the well. Current well data may also include rig sensed data, LWD/MWD data, and any lagged data that has been obtained.

It is noted that the current well data may not include data related to all of the properties and sensors mentioned in this disclosure. In practice, the instruments and sensors used in connection with drilling a well are selected based on a number of different factors. It is generally impracticable to use all of the sensors mentioned in this disclosure while drilling a well. In addition, even though certain instruments may be included in a BHA, for example, the data may not be available. This may occur because certain other data are deemed more important, and the available telemetry bandwidth is used to transmit only selected data.

It is also noted that a particular method for optimizing drill bit parameters may be performed multiple times during the drilling of a well. One particular instance of querying the data store for the current well data may yield updated or new data for a particular part of the formation that has already been drilled. This will enable the current optimization method to account for previous drilling conditions, as will be explained, even though those conditions were not previously known.

FIG. 10B shows three separate steps for correlating the current well data to the previously acquired data (at 503), predicting the next segment (at 504), and optimizing drilling parameters (at 505). Each of these will be described separately, but it is noted that in some embodiments, these steps may be performed simultaneously. For example, an ANN, as will be described, may be trained to optimize the drilling parameters using only previously acquired data and current well data as inputs. In this regard, the “steps” may be performed simultaneously by a computer with an installed trained ANN. Although this description and FIG. 10B include three separate “steps,” the present disclosure is not intended to be so limited. This format for the description is used only for ease of understanding. Those having skill in the art will appreciate that a computer may be programmed to perform multiple “steps” at one time. Thus, as real-time data is obtained, an ANN integral to a real-time optimization system may be restrained to incorporate additional data sets into the previously generated matrices. By allowing for continuous, and in certain embodiments “on the fly” ANN training, the determined optimized drilling parameters may be representative of real-time data from, for example, a prior segment of a drill bit run, as described above.

The method may next include correlating the current well data to previously acquired data, at step 503. There is, in general, a correspondence between the subterranean formations traversed by one well and that of a nearby well. A comparison or correlation of the current well data to that of an offset well (or other well drilled in the same area or a geographically similar area) may enable a determination of the position of the drill bit relative to the various structures and formations. In addition, the data from nearby wells, or wells in geologically similar areas, may provide information about the characteristics and properties of the formation rock.

A correlation of current well data to previously acquired data may include a determination of the formation properties of the current well. The current well formation properties may then be compared and correlated to the known formation properties from an offset well (or other well). It is noted that these properties may be determined from analysis of the previously acquired data. By identifying the relative position in the offset well that corresponds to the properties of the current well at a particular position, the relative position in the current well with respect to formation boundaries and structures may be determined. It is noted that formation boundaries and other structures often have changing elevations. A formation boundary in one well may not occur at the same elevation as the same boundary in a nearby well. Thus, the correlation is performed to determine the relative position in the current well with respect to the boundaries and structures.

In some embodiments, the current well data is analyzed by other parties, such as third party users and vendors. The other parties may determine the formation properties in the current well, and that information may be uploaded to the data store. In this case, the optimization method need not specifically include determining the formation properties.

In some embodiments, the formation properties are not specifically determined at all. Instead, the raw measurement data from the current well may be compared to similar data from the previously acquired data. In this aspect, the relative position in the current well may be determined without specifically determining the formation properties of the current well.

In some embodiments, a fitting algorithm may be used to correlate the current well data to the previously acquired data. Fitting algorithms are known in the art. In addition, a fitting algorithm may include using an error function. An error function, as is known in the art, will enable finding the correlation that provides the smallest differences between the current well data and the previously acquired data.

One of ordinary skill in the art will appreciate that the above described method for obtaining real-time data while drilling is merely an example of a method for obtaining such data. Real-time data may also be obtained by merely monitoring downhole conditions, as is well known in the art. Thus, the data provided to an ANN and/or a real-time optimization system may include raw and/or previously analyzed data. In certain embodiments, it may be preferable to provide a real-time optimization system with at least partially analyzed data so as to increase the speed of the calculations performed by the system. However, in certain embodiments, it may be preferable to provide the real-time optimization system with substantially raw data, and thereby allow the system to, for example, analyze the data, distribute the data among the ANNs for further training, or otherwise process the data in accordance with embodiments described herein.

Method for Training an Artificial Neural Network

In general, training an ANN includes providing the ANN with a training data set. A training data set includes known input variables and known output variables that correspond to the input variables. The ANN then builds a series of neural interconnects and weighted links between the input variables and the output variables. Using this training experience, an ANN may then predict unknown output variables based on a set of input variables.

To train the ANN to determine formation properties, a training data set may include known input variables (representing well data, e.g., previously acquired data) and known output variables (representing the formation properties corresponding to the well data). After training, an ANN may be used to determine unknown formation properties based on measured well data. For example, raw current well data may be input to a computer with a trained ANN. Then, using the trained ANN and the current well data, the computer may output estimations of the formation properties.

Additionally, training an ANN in accordance with the present disclosure may include providing the ANN with historical bit run data. Such historical data may include data collected during the drilling of prior wells, as well as empirical data representing wellbore conditions of previous wells. Thus, in one embodiment data collected during, for example, the method for collecting real-time drilling data, may be preserved and input into an ANN training program. An ANN training program may serve as a collection location for different types of experience data, such as, for example, historical bit run data, optimized bit/BHA studies, optimized drill string/tool assembly studies, and other studies as are known by those of ordinary skill in the art. The ANN training program may assemble such data sources, and develop secondary ANNs that may be used to analyze specific components of a drilling operation.

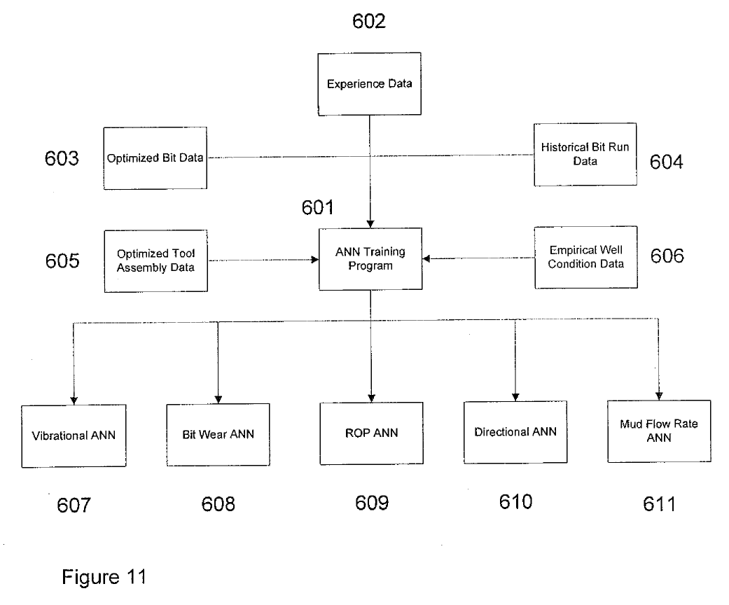

Referring to FIG. 11, a flowchart diagram of a method of training an ANN in accordance with an embodiment of the present disclosure is shown. In one embodiment, an ANN training program 601 may collect and process data from a number of different sources including, experience data 602, optimized bit data 603, historical bit run data 604, optimized tool assembly data 605, and empirical well condition data 606. Training ANN 601 may collect data from any of the above mentioned sources, process the data, and produce a trained ANN targeting a specific tool assembly or wellbore condition. Examples of such trained ANNs may include, a vibrational ANN 607, a bit wear ANN 608, a ROP ANN 609, a directional ANN 610 and/or a mud flow rate ANN 611.

Further, it is noted that although correlating current well data to previously acquired data may be done entirely by a computer, in certain embodiments, it may also include human input. For example, a human may check a particular correlation to ensure that a computer (possibly including an ANN) has not made an error that would be immediately identifiable to a person skilled in the art. If such an error is made, an optimization method operator may intervene to correct the error.

Predicting the formation properties may be done using a trained ANN. In such embodiments, the ANN may be trained using a training data set that includes the previously acquired data and the correlation of well data to offset well data as the inputs and known next segment formation properties as the outputs. Using the training data set, the ANN may build a series of neural interconnects and weighted links between the input variables and the output variables. Using this training experience, an ANN may then predict unknown formation properties for the next segment based on inputs of previously acquired data and the correlation of the current well data to the previously acquired data.

As mentioned above, one such type of trained ANN may include a vibrational analysis ANN 607. Such an ANN may be useful in analyzing drill string assembly or drill bit vibrations during drilling. Methods for dynamically simulating cutting tool and bit vibrations are disclosed in U.S. Patent Publication No. 2005/0273302, titled Dynamically Balanced Cutting Tool System, assigned to the assignee of the present invention, and incorporated herein in its entirety. Such calculations and processes necessary for the simulation of cutting tool and bit vibrations may be performed during the training of vibrational ANN 607, so vibrational ANN 607 includes a database of stored drilling conditions and drilling parameters affecting the conditions contained therein.

Subsequently, when real-time drilling data is input into vibrational ANN 607, the ANN may process the data, based on the stored drilling parameters and conditions, and provide an analysis of real-time drilling conditions based on the stored, processed and calculated data. Because the time consuming task of calculating potential outcomes based on a given drilling scenario may have been substantially determined by the trained ANN prior to drilling, when real-time data is input into vibrational ANN 607, the calculations will be processed relatively quickly. Due to the use of a trained ANN, calculations of real-time data may occur in a matter of minutes rather than take hours, as may currently occur.

In some embodiments, training ANN 601 may be integral to a real-time optimization system. In such an embodiment, as real-time data is collected, the data may be fed into training ANN 601 for further analysis. The analyzed data may then be used to farther train ANNs targeting a specific area of drilling and/or wellbore condition. One of ordinary skill in the art will appreciate that the above described method of training an ANN is merely exemplary of one type of training method. Other methods in accordance with embodiments described herein may also be used to train ANNs alone or in addition to the methods explicitly described above.

Method for Real-Time Drilling Optimization

Referring back to FIG. 4, before a set of recommended optimized drilling parameter may be determined, data from the current well drilling operation should be input into the real-time drilling optimization system 52. Such current well drilling data may include, for example, current well drilling parameters 51 (e.g., current well plan, well path, and mud weight data), real-time data from the drilling operation 50 (as discussed above as “Methods for Obtaining Real-time Data while Drilling”), and/or offset well formation data. Such data is analyzed by selected trained neural networks, as described above, and the stored drilling scenarios and analyzed experience data is compared to current well drilling data. As current well drilling data may contain information useful in determining, for example, rock mechanical (compressive forces), lithologic data, and abrasion data (bit wear data), for a drill run, analysis of such data in a trained ANN may allow the drilling operator to better determine optimal drilling parameter ranges for such factors as WOB and RPM.

In one embodiment, current well drilling data is input (either manually or automatically, as described above) into a trained ANN, the ANN then compares the data with the analyzed experience data, and the ANN provides recommended ranges for drilling parameters. A discussion of such drilling parameter ranges is discussed in greater detail is U.S. Patent Application Ser. No. 60/765,557, titled Method of Real-Time Drilling Simulation, assigned to the assignee of the present invention, and hereby incorporated by reference in its entirety. The drilling operator may then adjust the drilling parameters according to the ANN-provided drilling parameter ranges.

In certain embodiments, the ANN may be programmed to associate and provide output to promote drilling parameter ranges that will, for example, increase ROP, decrease vibration, or reduce bit wear, over a specified distance of the bit run. Thus, the ANN may provide data that makes a portion of the bit run effective according to one consideration at the expense of a secondary consideration. As an example, in one embodiment, a drilling operator's primary concern may be to increase ROP. To promote the greatest ROP, the ANN may be programmed to provide suggested drilling parameter ranges that provide for the greatest potential ROP, even if such parameters may result in increased bit wear. Thus, an ANN in accordance with embodiments disclosed herein, may be programmed to take into account the preferred method of operation at a specified drilling operation.

In another embodiment, the mud flow rate may be optimized, for example, to determine a mud flow rate for optimal cuttings removal, based on the rock properties. In such an embodiment, a mud flow rate ANN 611, may be trained by ANN training program 601 to include matrices of analyzed data relating to mud flow rates. During training of mud flow rate ANN 611, mud flow data including mud flow rates in a specified formation using known drilling fluids may be recorded an analyzed. Drilling mud parameters provided to mud flow rate ANN 611 during training may include, for example, mud weight, density, viscosity, gel strength, content, and pH. During training, such drilling mud parameters may be analyzed by mud flow rate ANN 611 according to the results of the mud in a known lithology.

During real-time drilling optimization, real-time data including drilling mud parameters may be provided to mud flow rate ANN 611, and the ANN may then recommend optimal mud flow rates. Thus, in a selected embodiment, the known and real-time provided drilling mud parameters may be used in conjunction with the properties of the formation to determine an optimal flow rate. In some embodiments, mud flow rate ANN 611 may further interface with, for example, vibrational ANN 607, bit wear ANN 608, ROP ANN 609, or directional ANN 610 to provide recommendations based on their corresponding data sets. Thus, optimal flow rates provided by mud flow rate ANN 611 may be used by, for example, ROP ANN 609 to determine a recommended mud flow to provide for optimal cuttings removal during a desired and/or optimized rate of penetration. Accordingly, one of ordinary skill in the art will appreciate that mud flow rate ANN 611, in certain embodiments, may interface with ANN training program 601 or any trained ANN, so as to provide optimized mud flow rate data.

In another embodiment, an input may include a proposed well path, and the proposed well path may be analyzed in directional ANN 610. In such an embodiment, directional ANN 610 may have been previously trained by ANN training program 601 by providing historical well logs, simulated results, and/or additional directional well drilling information available during ANN training, as discussed above. During drilling operations, well drilling data including real-time drilling data, deviation, current path, and projected drilling path may be input into directional ANN 610. Using such real-time data, directional ANN 610 may determine optimal drilling parameters to allow the drill bit to stay on the projected path. On method of determining optimal drilling parameters for specified directional drilling may include directional ANN 610 interfacing with ANN training program 601 and/or interfacing with an additional trained ANN, such as, for example, vibrational ANN 607, bit wear ANN 608, ROP ANN 609, and/or mud flow rate ANN 611.

In an exemplary embodiment of an interfacing system using directional ANN 610, current real-time data analyzed by vibrational ANN 607 may supply vibrational data to directional ANN 610. The recommend drilling parameters supplied by vibrational ANN 607 to provide a defined vibrational signature may be incorporated by directional ANN 610 to determine the effect of the recommended drilling parameters by vibrational ANN 607 on the direction of drilling. If the direction of drilling does not deviate substantially from the desired direction, as specified by a drilling operator, then directional ANN 610 may allow the recommended drilling parameters as supplied by the vibrational ANN 607 to control the drilling. However, if the direction of drilling would vary outside of a predefined acceptable range (i.e., a range defined by a drilling operator to achieve a directional objective), then directional ANN 607 may provide alternate instructions on parameters to keep the direction of drilling within the acceptable range. In some embodiments, directional ANN 607 may interface directly with other trained ANNs. However, in alternate embodiments, the calculations of directional ANN 607 may provide the drilling operator with optimized drilling parameters and/or recommended adjustments to provide a specified drilling direction. Such drilling recommendations may be provided, for example, through graphs, calculations, three-dimensional modeling, and/or any other graphic visualization techniques as described above. Additionally, one of ordinary skill in the art will appreciate that directional ANN 607 may interface with more than one trained ANN when determining optimized drilling parameters for a given directional drilling operation.

According to alternate embodiments, a method for optimizing drilling parameters may include predicting optimized parameters for the entire run of a bit to a planned depth. Such a method may include consideration of predicted formation properties for the entire run based on correlations of the current well data to previously acquired data analyzed by a trained ANN. Thus, in certain embodiments, the trained ANN may include the comparison of current well drilling data against predicted wellbore data (including predicted formation/lithologic data) to determine appropriate drilling parameters for a future section of the bit run.

Those of ordinary skill in the art will appreciate that embodiments in accordance with the present disclosure may include ANNs that are trained to promote any number of given factors to make the drilling of a wellbore more efficient. The limited embodiments discussed above are meant to be illustrative examples of how a trained ANN may be used in a real-time drilling optimization system.

Additionally, in certain embodiments, simulating drilling in real-time may include use of a data store in which data is collected prior to use in other aspects of the drilling simulation. In such an embodiment that data store may accept data inputs including analyzed material samples and formation information, and save such data prior to analyzation in, for example, and ANN based system. Further explanation of such data store systems are described in greater detail below.

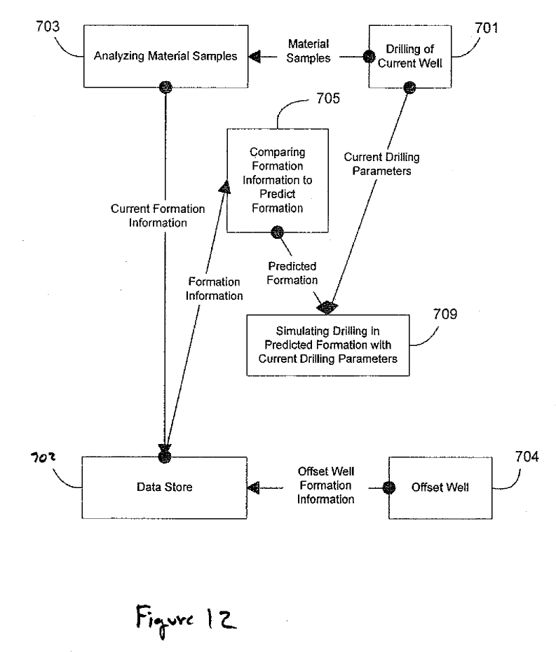

Referring now to FIG. 12, a flow diagram of a method for simulating drilling in real-time in accordance with an embodiment of the invention is shown. Material samples are collected from drill cuttings from drilling 701 of a current well. The material samples are then analyzed 703, and current formation information that is derived from analyzing 703 of the material samples is stored in a data store 702. Offset well formation information from an offset well 704 in the vicinity of the current well is also stored in the data store 702. Data store 702 also has stored in it historical formation information. The current formation information is compared 707 to the offset well formation information and the historical formation information. Based on comparing 705, a formation section to be drilled is predicted. With current drilling parameters that are being used in drilling 701 of the current well, a dynamic response of the drilling tool assembly is simulated 709 in the predicted formation.

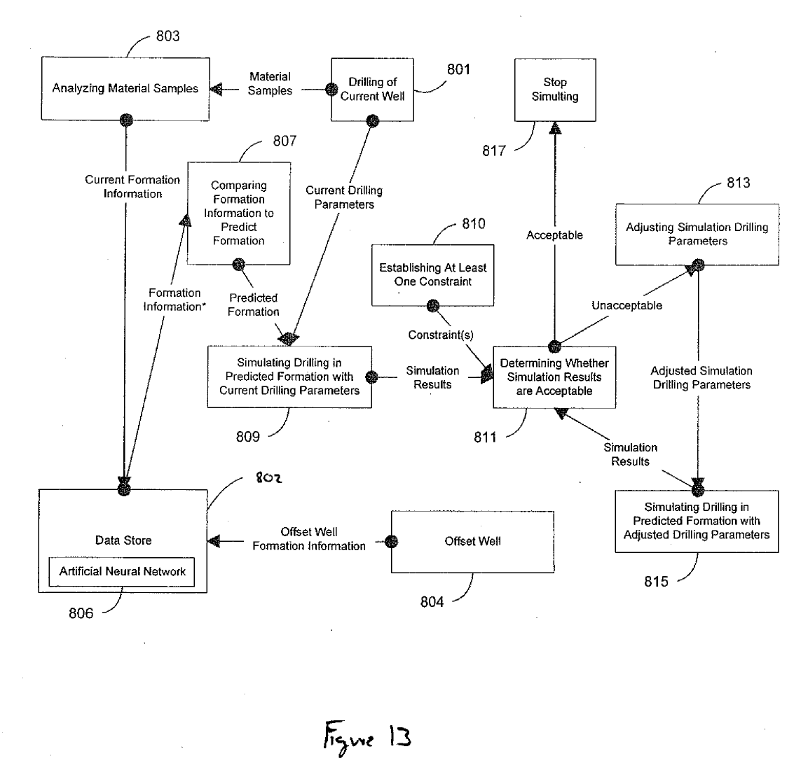

Referring now to FIG. 13, a flow diagram of a method for simulating drilling in real-time in accordance with a preferred embodiment of the invention is shown. Material samples are collected from drill cuttings from drilling 801 of a current well. The material samples are then analyzed 803, and current formation information that is derived from analyzing material samples 803 is stored in a data store 802 including an ANN 806. Offset well formation information from an offset well 804 in the vicinity of the current well is also stored in data store 802 and is entered into ANN 806. Data store 802 also has stored in it historical formation information, the historical formation also being entered into the ANN. The ANN is trained by the current formation information, the offset well formation information, and the historical formation information. Current formation information is compared 807 to the offset well formation information and the historical formation information and from this comparing 807, a formation section to be drilled is predicted using the ANN. With current drilling parameters that are being used in drilling 801 of the current well, a dynamic response of the drilling tool assembly is simulated 809 in the predicted formation. At least one constraint on performance of the drilling tool assembly is established 810, and based on the at least one constraint, it is determined 811 whether results from simulating 809 are acceptable.

If the results from the simulating 809 are acceptable, simulating stops 817. However, if the results from simulating 809 are determined to be unacceptable, based on the at least one constraint, at least one drilling parameter is adjusted 813, and simulating 815 drilling in the predicted formation section is performed with the adjusted drilling parameters. It is again determined 811 whether the results from simulating 815 with adjusted drilling parameters are acceptable based on the at least one constraint. If the results from simulating 809 are acceptable, simulating stops 817. If the results from simulating 815 with adjusted drilling parameters are determined 811 to still be unacceptable based on the at least one constraint, adjusting 813 the at least one drilling parameter and simulating 815 with the at least one adjusted drilling parameter is repeated until the simulation yields acceptable simulation results based on the at least one constraint.

Advantageously, embodiments in accordance with the present disclosure may allow a drilling operator to adjust at least one drilling parameter according to real-time drilling conditions. Such drilling parameters may be determined continuously, or as needed, to promote drilling according to a desired well drilling plan. Thus, at any given depth, drilling parameters may be adjusted so as to promote drilling vibration management, bit life management, ROP management, well path management, or to promote other economic performance factors. As desired, the methods disclosed herein may allow a drilling operator to adjust drilling parameters substantially contemporaneously with changes in wellbore formation or drilling conditions to promote a more efficient drilling operation. Because such drilling parameter change recommendations may occur in real-time, or near real-time, the drilling parameters may be adjusted before negative repercussions from improper drilling parameters for a section of a wellbore, are realized. Additionally, the data calculated by embodiments of the present disclosure may be preserved (e.g., stored in a data store) for use as experience data for future drilling operations, thereby increasing the empirical data, and increasing the accuracy of using the most efficient drilling parameters for a given drilling operation.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the present disclosure should be limited only by the attached claims.

What is claimed is:

1. A method for optimizing drilling comprising:
identifying design parameters for a drilling tool assembly;
preserving the design parameters as experience data;
training at least one artificial neural network using the experience data;
collecting real-time data from the drilling operation;
analyzing the real-time data with a real-time drilling optimization system; and
determining optimal drilling parameters based on the analyzing the real-time data with the real-time drilling optimization system.

2. The method of claim 1, wherein the identifying design parameters comprises:
simulating a dynamic response of the drilling tool assembly;

3. The method of claim 1, wherein the design parameters comprise at least one of a group consisting of drill string design parameters, bottom hole assembly design parameters, and drill bit design parameters.

4. The method of claim 1, wherein the at least one artificial neural network is selected from at least one of a group of artificial neural networks consisting of vibrational, bit wear, and rate of penetration.

5. The method of claim 1, wherein the experience data comprises previously acquired data.

6. The method of claim 5, wherein the previously acquired data comprises historical bit run data.

7. The method of claim 1, further comprising:
predicting a drilling performance parameter based on the optimal drilling parameters.

8. The method of claim 7, wherein the drilling performance parameter is one of a group consisting of rate of penetration, rotary torque, rotary speed, weight on bit, lateral force on bit, ratio of forces on cones, ration of forces between cones, distribution of forces on cutting elements, volume of formation cut, well path maintenance, and wear on cutting elements.

9. The method of claim 1, further comprising:
adjusting the drilling operation according to the determined optimal drilling parameters.

10. The method of claim 8, wherein the adjusting comprises adjusting at least one of a weight on bit, mud flow rate, and a rotary speed.

11. The method of claim 1, wherein the real-time drilling optimization system comprises at least one artificial neural network.

12. The method of claim 1, wherein the at least one artificial neural network is selected from at least one of a group of artificial neural networks consisting of vibrational, bit wear, and rate of penetration.

13. The method of claim 1, wherein the experience data is stored in a data store.

14. The method of claim 13, wherein the experience data stored in the data store comprises alternative formation information.

15. The method of claim 14, wherein the alternative formation information comprises information from a material sample collected from a first formation segment.

16. A method for optimizing drilling in real-time comprising:
collecting real-time data from a drilling operation;
comparing the real-time data against predicted data in a real-time optimization system, wherein the real-time optimization system comprises at least one artificial neural network; and
determining optimal drilling parameters based on the comparing the real-time data with the predicted data in the real-time drilling optimization system.

17. The method of claim 16, wherein the at least one artificial neural network is selected from at least one of a group of artificial neural networks consisting of vibrational, bit wear, and rate of penetration.

18. The method of claim 16, further comprising:
collecting experience data.

19. The method of claim 18, wherein the experience data comprises data selected from at least one of a group of data consisting of data generated from drilling tool assembly design and historical bit run data.

20. The method of claim 16, wherein the real-time optimization system comprises a training artificial neural network.

21. The method of claim 20, wherein the training artificial neural network trains at least one artificial neural network.

22. A method for optimizing drilling in real-time comprising:
collecting real-time data from a first segment of a bit run;
inputting the real-time data into a real-time optimization system, wherein the real-time optimization system comprises at least one artificial neural network;
analyzing the real-time data from the first segment with the real-time drilling optimization system; and
determining optimal drilling parameters for a second segment of the bit run with the real-time drilling optimization system based on the analyzing the real-time data from the first segment.

23. The method of claim 22, wherein the at least one artificial neural network is selected from at least one of a group of artificial neural networks consisting of vibrational, bit wear, and rate of penetration.

24. The method of claim 22, further comprising:
predicting a drilling performance parameter based on the optimal drilling parameters.

25. The method of claim 24, wherein the drilling performance parameter is one of a group consisting of rate of penetration, rotary torque, rotary speed, weight on bit, lateral force on bit, ratio of forces on cones, axial force on cones, torsional force on cones, ratio of forces between cones, distribution of forces on cutting elements, volume of formation cut, and wear on cutting elements.

26. The method of claim 22, further comprising:
adjusting a drilling operation according to the determined optimal drilling parameters.

27. The method of claim 26, wherein the adjusted optimal drilling parameter is one of a group consisting of rate of penetration, rotary torque, rotary speed, weight on bit, lateral force on bit, ratio of forces on cones, ration of forces between cones, distribution of forces on cutting elements, volume of formation cut, and wear on cutting elements.
